(19) United States
(12) Patent Application Publication
(10) Pub. No.: US 2022/0061332 A1
(43) Pub. Date: Mar. 3, 2022

(54) COMPOSITIONS AND METHODS FOR PROVIDING PLANTS WITH TOLERANCE TO HEAT STRESS

(71) Applicant: King Abdullah University of Science and Technology, Thuwal (SA)

(72) Inventors: Heribert Hirt, Thuwal (SA); Kirti Shekhawat, Thuwal (SA); Maged Saad, Thuwal (SA)

(21) Appl. No.: 17/473,758

(22) Filed: Sep. 13, 2021

Related U.S. Application Data
(63) Continuation-in-part of application No. 16/072,137, filed on Jul. 23, 2018, now Pat. No. 11,118,159.
(60) Provisional application No. 62/281,404, filed on Jan. 21, 2016.

(51) Int. Cl. A01N 63/20

(52) U.S. Cl. CPC A01N 63/20

(57) ABSTRACT

Compositions containing Enterobacter sp. SA187 and methods of use thereof to enhance plant development and yield under environmental stress conditions such as heat stress, are provided. The compositions include plant substrates containing an effective amount of Enterobacter sp. SA187 to inhibit or reduce abiotic stress in the plant. In a preferred embodiment suitable plant substrates include, but are not limited to soil, peat, compost, vermiculite, perlite, sand, clay and combinations thereof. Another embodiment provides plants inoculated with an amount of SA187 to provide abiotic stress tolerance, enhance yield, enhance biomass, or a combination thereof. Examples include non-desert plants which include but are not limited to crop plants that are not indigenous to desert environment.

### CROSS REFERENCE TO RELATED APPLICATIONS

This application is a continuation-in-part of U.S. Ser. No. 16/072,137, filed on Jul. 23, 2018, as a National Phase application under 35 U.S.C. § 371 of International Application No. PCT/IB2017/050314, filed on Jan. 20, 2017, entitled “COMPOSITIONS AND METHODS FOR PROVIDING PLANTS WITH TOLERANCE TO ABIOTIC STRESS CONDITIONS”, which claims benefit of and priority to U.S. Provisional Patent Application No. 62/281,404 filed on Jan. 21, 2016, and where permissible are incorporated herein in their entirety.

### FIELD OF THE INVENTION

This invention is generally in the field of compositions and methods for conferring tolerance to conditions such as heat stress, to plants.

### REFERENCE TO SEQUENCE LISTING

The Sequence Listing submitted 3 Nov. 22, 2021 as a text file named “KAUST_2022_020_01_ST25.txt” created on Jan. 20, 2017, and having a size of 5,501,229 bytes is hereby incorporated by reference.

### BACKGROUND OF THE INVENTION

The United Nations predicts that the world population will reach 8.5 billion by 2030 (UN News Centre, 2015). A key challenge for feeding the world population is the global water shortage which limits crop yields in more than 70% of arable lands (Timmusk, et al., PLOS One, 9(5) 1-13 (2014)). Abiotic stresses, such as drought, heat and salt, are the most important limiting factors in agriculture not only in Saudi Arabia but worldwide. These environmental stresses are the cause of more than 50% of crop losses globally (FIG. 1).

Among other effects, global warming increases average temperatures and causes severe heat waves, challenging plant growth, and agriculture worldwide (Mittler & Blumwald, 2010; Ling et al, 2018). Elevated temperatures cause severe cellular injury to plants resulting in a collapse of cellular organization and inhibition of plant growth (Abd El-Daim et al, 2014).

Major efforts are underway on improving plant stress tolerance by molecular breeding and genetic manipulation (GM) techniques. However, these processes are long term investments of high costs and require extensive registration procedures before marketing of the products is possible.

An alternative approach to improve plant stress tolerance has been largely overlooked in the past decades is to make use of rhizosphere microbes which offer a cheap GM-free alternative.

Therefore, it is an object of the invention to provide compositions and methods for providing plants with resistance or tolerance to abiotic stress conditions such as heat stress.

It is another object of the invention to provide seed coating compositions that provide plants with resistance or tolerance to heat stress conditions.

It is still another object to provide methods for growing plants under heat stress conditions.

### SUMMARY OF THE INVENTION

The methods and compositions disclosed herein are based on the discovery that Enterobacter sp. SA187 (hereafter named SA187) can provide resistance or tolerance to abiotic stress conditions (such as heat stress) to seeds or plants. Compositions containing SA187 can be used to enhance plant development and yield under environmental stress conditions. In one embodiment, the stress is salt stress. In another embodiment, the stress is heat stress. One embodiment provides an isolated culture of SA187. In another embodiment, the SA187 is genetically modified to express one or more heterologous genes or proteins.

The desert endophytic bacterium SA187 confers abiotic stress tolerance and enhances yield and biomass production of model and crop plants, respectively, using a 2-keto-4-methylbutyric acid (KMBA) dependent ethylene signaling activation. SA187 colonizes both surface and inner plant root and shoot tissues, to modify several plant phytohormone pathways. Transcriptome and genetic studies showed that the ethylene signaling pathway was the major contributor for mediating abiotic stress tolerance by SA187. Interestingly, neither plants nor SA187 produce ethylene directly, but upon colonization, plants induce expression of the methionine salvage pathway in SA187 to produce KMBA that is subsequently converted to ethylene in planta.

One embodiment provides a plant substrate containing an effective amount of Enterobacter sp. SA187 to inhibit or reduce abiotic stress in the plant. In a preferred embodiment suitable plant substrates include, but are not limited to soil, peat, compost, vermiculite, perlite, sand, clay and combinations thereof.

Another embodiment provides a non-desert plant inoculated with an amount of SA187 to provide abiotic stress tolerance, enhance yield, enhance biomass, or a combination thereof. Preferred non-desert plants include but are not limited to crop plants that are not indigenous to desert environment.

The disclosed compositions and methods can provide tolerance or resistance to abiotic stress conditions including, but not limited to drought, high heat, high salt, bright light, ultraviolet light, too high (heat stress) and too low temperatures, freezing, heavy metals and hypoxia.

Still another embodiment provides a plant substrate inoculated with SA187 and one or more additional plant growth-promoting bacteria and/or one or more plant growth-promoting rhizobacteria. Exemplary additional plant growth-promoting bacteria or rhizobacteria include but are not limited to Pseudomonas putida, Pseudomonas aeruginosa, Klebsiella sp., Enterobacter asburiae, Rhizobium sp. (pea), Mesorhizobium sp., Acinetobacter spp., Rhizobium sp. (lentil), Pseudomonas sp. A3R3, Psychrobacter sp. SRS8, Bradyrhizobium sp., Pseudomonas aeruginosa 4EA, Pseudomonas sp., Ochrobactrum cytisi, Bacillus species PSB10, Paenibacillus polymyxa, Rhizobium phaseoli, Rahnella aquatilis, Pseudomonas fluorescens, Ralstonia metallidurans, Azospirillum amazonense, Serratia marcescens, Enterobacter sp., Burkholderia, Pseudomonas jessenii, Azotobacter sp., Mesorhizobium ciceri, Azotobacter chroococcum, Klebsiella oxytoca, Pseudomonas chlororaphis, Bacillus subtilis, Gluconacetobacter, diazotrophicus, Brevibacillus spp., Bravibacterium sp., Xanthomonas sp. RJ3, Azomonas sp. RJ4, Pseudomonas sp. RJ10, Bacillus sp. RJ31, Bradyrhizobium japonicum, Variovorax paradoxus, Rhodococcus sp., Flavobacterium, Sphingomonas sp, Mycobacterium sp, Rhodococcus sp, Cellulomonas sp., Azospirillum sp., Azospirillum brasilense, Rhizobium meliloti, Kluyvera ascorbata, Rhizobium cicero, Rhizobium leguminosarum, Paenibacillus polymyxa strain A26, a Alcaligenes faecalis strain AF, and combinations thereof.

Yet another embodiment provides a plant seed coated with an effective amount of SA187 to provide the seed with resistance to abiotic stress conditions as the seed grows. The coating can contain one or more additional plant growth-promoting bacteria or rhizobacteria.

Another embodiment provides a plant root coated with SA187 optionally including one more additional plant growth-promoting bacteria or rhizobacteria.

Still another embodiment provides a method of providing a seed or plant with resistance to abiotic stress conditions by coating the seed or a root of the plant with an effective amount of SA187 to provide the seed or plant with resistance to the abiotic stress conditions.

Yet another embodiment provides a method of improving growth of a seed or plant under abiotic stress conditions by growing the seed or plant in a plant substrate, wherein the plant substrate comprises an effective amount of SA187 to colonize the seed or a root of the plant to provide abiotic stress resistance to the seed or plant.

Another embodiment provides a method of improving tolerance of a seed or plant to abiotic stress conditions by coating the seed or root of the plant with an effective amount of SA187 to provide the plant with resistance to abiotic stress.

Still another embodiment provides a method of improving tolerance of a seed or plant against abiotic stress conditions by growing the seed or plant in a plant substrate comprising an effective amount of SA187 to provide the seed or plant with tolerance to the abiotic stress conditions.

Yet another embodiment provides a method of providing a plant with abiotic stress resistance by inoculating the plant's rhizosphere with SA187.

Another embodiment provides a seed coating composition containing SA187. The SA187 can be encapsulated with a non-toxic, biodegradable coating. The seed coating composition can also contain a coating adhesive. Exemplary seed coating compositions contain gelatin, cellulose, alginate, xanthum, or a combination thereof. Certain seed coating compositions can have multiple layers.

One embodiment provides SA187 whose genome contains SEQ ID NO: 1, 2, 3, 4, 5, 6, 7, 8, 9, 10, 11, 12, 13 as disclosed in U.S. Ser. No. 16/072,137, or a combination thereof. In still another embodiment provides SA187 whose genome contains all of SEQ ID NO: 1-13 as disclosed in U.S. Ser. No. 16/072,137.

### BRIEF DESCRIPTION OF THE DRAWINGS

FIG. 1 is bar graph of various crops showing the percent average yield for average yield as % of record (open box), losses due to abiotic stresses as a % of record yield (solid black box), and losses due to biotic stresses as % of record (solid grey box). Data taken from Buchanan et al, Am Soc Plant Physiol. 1367 (2000).

FIG. 2A is a bar graph of root length (cm) for 13 day old Arabidopsis seedlings treated for 8 days with ½ MS (control condition; left column) and 100 mM NaCl (salt condition; right column) for plants inoculated with (+SA187) and plants without (−SA187). FIG. 2B is a bar graph of lateral root density (cm) for 13 day old Arabidopsis seedlings treated for 8 days with ½ MS (control condition; left column) and 100 mM NaCl (salt condition; right column) for plants inoculated with (+SA187) and plants without (−SA187).

FIG. 3 is a bar graph showing the fresh weight (mg) of 17 day old Arabidopsis seedlings treated for 12 days with ½ MS (control condition, left column) and 100 mM NaCl (salt condition, right column) for plants inoculated with (+SA187) and plants without (−SA187).

FIG. 4A is a photograph of germinating Arabidopsis thaliana seeds grown on ½ MS containing 107 bacteria per plate (left panel) with (+SA187) or without (−SA187). Five day old seedlings were then transferred to ½ MS+/−100 mM NaCl plates (right panel). Photographs were taken after 10 days of treatment. FIG. 4B is a photograph of germinating Arabidopsis thaliana seeds grown on ½ MS containing 10 bacteria per plate (left panel) with (+SA187) or without (−SA187). Five day old seedlings were then transferred to ½ MS+/−100 mM NaCl plates (right panel). Photographs were taken after 20 days of treatment.

FIG. 5 is a bar graph of fresh weight (mg) of 17 day old Arabidopsis seedlings treated for 12 days with ½ MS (control, left column) and 5% PEG (drought mimicking condition, right column) treated with (+SA187) or without (−SA187) SA187.

FIG. 6 is a bar graph of rosette fresh weight (g) of Arabidopsis plants submitted to a 3 week drought treatment as in FIG. 5 with (+SA187) or without (−SA187).

FIG. 7A is a bar graph of plant biomass per plot (gr) of Durum wheat inoculated with (+SA187) or without (−SA187). FIG. 7B is a bar graph of seed weight per plot (gr) of Durum wheat inoculated with (+SA187) or without (−SA187). FIG. 7C is a bar graph of spike height (cm) of Durum wheat inoculated with (+SA187) or without (−SA187). FIG. 7D is a bar graph of number of seeds per spike of Durum wheat inoculated with (+SA187) or without (−SA187) Enterobacter endophyticus sp. nov.

FIG. 8A is a photograph of SA187-colonized 25-day-old Arabidopsis plants showing enhanced growth under salt stress. FIGS. 8B and 8D are graphs showing growth parameters of 17-day-old SA187-colonized seedlings exposed to salt stress (½ MS+100 mM NaCl) or osmotic stress (−0.5 MPa) (FIG. 8D). Root hair length was measured on 5-day-old seedlings. FIG. 8C is a bar graph of shoot Na+/K+ ratio of SA187-colonized seedlings exposed to salt stress for 12 days. FIG. 8E is a photograph showing increased survival into heat stress in Arabidopsis inoculated with SA187. FIG. 8E is a graph of phenotype and FIG. 8F is a bar graph of heat survival rate of one-week-old SA187-colonized or mock-treated Arabidopsis seedlings exposed to heat stress. FIG. 8G is a graph of growth parameters of SA187-colonized 140-day-old field-grown durum wheat plants. FIGS. 8H, and 8I are graphs showing growth parameters of SA187-colonized 25-day-old field-grown alfalfa plants using 2 water regimes, normal and high salinity. Percentages indicate improvement of SA187-colonized plants compared to mock-treated plants. Asterisks indicate statistical difference based on the Mann-Whitney test between mock- and SA187-treated plants under the same conditions (**P<0.01, ***P<0.001).

FIG. 9A is a bar graph of plant height under salinity conditions when treated with SA187. FIG. 9B is a bar graph of biomass of plants treated with SA187 and cultured under salinity conditions. FIG. 9C is bar graph of dry yield of plants treated with SA187 and cultured under salinity conditions.

FIG. 10A is a hierarchical clustering (Euclidian distances) of deregulated genes in response to SA187, salt or both. FIG. 10B are bar graphs of Salicylic acid (SA), abscisic acid (ABA) and jasmonic acid (J A) content of SA187-colonized or mock-treated plants after growth on ½ MS+/−100 mM NaCl for 12 days. FIG. 10C are bar graphs of fresh weight and beneficial index of SA187-treated mutants in hormonal pathways under salt stress during 12 days. FIG. 10D is a graph showing 100 nM ACC and 1 μM KMBA partially mimic the beneficial effect of SA187 during salt stress treatment. FIG. 10E shows qPCR analysis of expression of SA187 methionine salvage cycle genes under salt stress conditions: SA187-inoculated plants versus SA187 alone incubated in synthetic broth.

FIG. 11 is a bar graph of total fresh weight of 18-d-old Arabidopsis seedlings on medium with ethylene synthesis/signaling inhibitors. SD are displayed.

FIG. 12A-12G show the effect of SA187 on thermotolerance in wheat and Arabidopsis. FIG. 12A shows the phenotype of non-colonized (Mock) and SA187-colonized (187) 5-day-old wheat seedlings after HS treatment at 44° C. for 2 h. FIG. 12B shows fresh weight quantification of 9-day-old wheat seedlings upon 44° C. heat stress (HS) and 22° C. normal (NHS) conditions (without and with SA187) after 3 days of recovery at 22° C. FIG. 12C shows plant biomass of wheat obtained upon cultivation with and without SA187 in three consecutive growing seasons of open-field agriculture. FIG. 12D shows the experimental scheme of heat experiments and phenotype of Arabidopsis seedlings with and without SA187. Top, plants with long-term acquired thermotolerance (LAT) treatment: 9-day-old plants that were grown at 22° C. were treated at 37° C. for 3 h and then returned to 22° C. for 2 day. At day 11, plants were heat-stressed at 44° C. for 30 min and incubated for recovery at 22° C. Middle, plants with HS treatment: 11-day-old plants that were grown at 22° C. were treated at 44° C. for 30 min and incubated for recovery at 22° C. Bottom, plants with NHS treatment: control plants were grown in parallel at 22° C. for 15 days. FIG. 12E shows the fresh weight of 15-day-old plants with and without SA187 under NHS, HS, and LAT temperature regimes. FIG. 12F shows percent survival of 15-day-old plants with and without SA187 under NHS, HS, and LAT conditions. FIG. 12G shows percentage of bleached and green leaves of 15-day-old plants with and without SA187 under NHS, HS, and LAT conditions. Data information: Dashed lines indicate the heat acclimation on day 9 at 37° C. for 3 h; HS treatment on day 11 at 44° C.; sampling time for targeted transcriptome after recovery at 22° C. for 1, 24, 48, 72 h, and 4 days: RNA-seq analysis, fresh weight, percent survival, and bleached/green leaves measurements after recovery at 22° C. for 4 days. For percent survival, plants with green leaves were scored as live plant out of 12 plants for each biological repeat in different temperature treatments. For bleached and green leaves, a total no. of green and bleached leaves were scored per 12 plants and were divided by 12 to score number of green and bleached leaves/plant. All treatments are compared with direct 44° C. heat-stressed plants. Plots represent the mean of 3 biological replicates (n=36, 12 plants/biological repeat for Arabidopsis and n=27, 9 plants/biological repeat for wheat seedlings). Error bars represent SE (1B, C, F), SD (1E, G). Asterisks indicate a statistical difference based on the Mann-Whitney test (*P<0.05) for the field data and Student's t-test (*P≤0.05; **P≤0.01; ***P≤0.001) for the Arabidopsis data. Scale bars correspond to 1 cm. Source data are available online for this figure.

FIGS. 13A-13E show transcriptome analysis of thermoprimed- and SA187-induced thermotolerance in Arabidopsis plants. FIGS. 13A and 13B shows Venn diagrams representing the number of up- and down-regulated DEGs in response to HS (HS, LAT) with and without SA187 compared to NHS and NHS+187. The histograms show enriched GO terms for unique up- and down-regulated HS DEGs when compared to NHS. FIG. 13C shows hierarchical clustering of up- and down-regulated DEGs in Arabidopsis in response to HS and HS+187 treatments. For every gene, FPKM values were normalized. Red bars denote an increase, while green bars indicate a decrease in expression for a given gene. For the most relevant clusters, gene families significantly enriched are indicated based on gene ontology. The pink line in each cluster indicates an overall trend of differentially expressed genes in a particular cluster for different treatments. FIGS. 13D and 13E shows Venn diagrams showing the number of commonly up-regulated (FIG. 13D) and down-regulated (FIG. 13E) DEGs in response to HS+187 and LAT in comparison to HS. The histograms represent the enriched GO terms associated with the DEGs. Data information: RNA-seq experiments were performed in three biological replicates. 5-day-old seedlings±SA187 were transferred to new ½ MS plates before HS treatment. The RNA-seq was performed with LAT: 9-day-old plants that were grown at 22° C. were treated at 37° C. for 3 h and then returned to 22° C. for 2 days. At day 11, plants were heat-stressed at 44° C. for 30 min and incubated for recovery at 22° C. for 4 days. HS: 11-day-old plants that were grown at 22° C. were treated at 44° C. for 30 min and incubated for recovery at 22° C. for 4 days to perform RNA-seq. Non-HS (NHS): control plants were grown in parallel at 22° C. for 15 days.

FIGS. 14A-14G show SA187-induced thermotolerance is associated with higher expression of heat-responsive genes and chromatin modification. FIGS. 14A-14B show the dynamics of HSFA2 and HSP101 transcript levels in control (NHS, NHS+187), 44° C. heat-stressed non-colonized and SA187-colonized (HS, HS+187), thermoprimed (LAT), and thermoprimed and SA187-colonized plants (LAT+187) at 1, 24, 48, 72, and 96 h of recovery at 22° C. SA187-colonized (HS+187) and thermoprimed (LAT) plants showed higher transcript levels in comparison to plants exposed at 44° C. HS for 30 min (HS) after 1 h of recovery at 22° C. FIGS. 14C-14D show the transcript levels of heat stress memory genes HSP18.1 and APX2 in control plants (NHS, NHS+187), 44° C. heat-stressed non-colonized and SA187-colonized (HS, HS+187), thermoprimed (LAT), and thermoprimed SA187-colonized plants (LAT+187) at 1, 24, 48, 72, and 96 h of recovery at 22° C. Transcript levels were normalized to tubulin as reference gene, and the respective 22° C. NHS plants were harvested at the same time points. All treatments are compared with direct 44° C. HS treatment for statistical significance. FIG. 14E shows a schematic representation of the experimental set-up and sampling times for ChIP-PCR. 9-day-old plants were thermoprimed at 37° C. for 3 h before incubation at 22° C. for 24 h or 72 h. FIG. 14F shows APX2 and HSP18.2 gene models drawn to scale (gray boxes, 50 untranslated region; orange boxes, exons; angled arrow, transcription start site). The underneath numbers with gray bar indicate the positioning of regions analyzed for ChIP-PCR, three regions of APX2 and 2 regions of HSP18.2. FIG. 14G shows Relative enrichment of H3K4me3 at APX2 and HSP18.2 in control non-primed (NP), SA187-colonized non-primed plants (NP+187), 37° C.-primed (P), and 37° C. primed SA187-colonized plants (P+187) at 24 and 72 h after priming as determined by chromatin immunoprecipitation-qPCR for the indicated regions of APX2 and HSP18.2. Amplification values were normalized to input and H3 and region 1 of non-primed (NP) plants. Data information: All plots represent the means of 3 biological replicates. Error bars represent SE. Asterisks indicate a statistical difference based on Student's t-test (*P≤0.05; **P≤0.01; ***P≤0.001 for differences between NP in comparison to NP+187, P and P+187 treatments). FIG. 14H shows phenotype of hsfa2 and hsfa2 complementation lines with and without SA187. Top, 11 days old plants without SA187 were heat stressed at 44° C. for 30 min and incubated for recovery at 22° C. Bottom, 11 d old plants with SA187 that were grown at 22° C. were treated at 44° C. for 30 min and incubated for recovery at 22° C. FIG. 14I shows fresh weight of 15 d old plants under different temperature regimes. FIG. 14J shows percent survival of plants. All plots represent the mean of 3 biological replicates (n=36). Error bars represent SE. Asterisks indicate a statistical difference based on the Student's t-test (*P≤0.05).

FIGS. 15A-15F show the involvement of ethylene and HSFA2 signaling on SA187-induced thermotolerance in Arabidopsis. FIG. 15A shows phenotypes of SA187-colonized or non-colonized wild-type Col-0, hsfa2, hsfalq, and ein3-1 mutant plants upon long-term acquired thermotolerance treatment (LAT): 9-day-old plants without and with SA187 (LAT, LAT+187) were treated at 37° C. for 3 h and then returned to 22° C. for 2 days. At day 11, plants were heat stressed at 44° C. for 30 min and incubated for recovery at 22° C.; or direct heat stress treatment (HS): 11-day-old plants without and with SA187 (HS, HS+187) were treated at 44° C. for 30 min and incubated for recovery at 22° C. FIGS. 15B and 15C show fresh weight and percent survival of Col-0, hsfa2, hsfalq, and ein3-1 plants in HS, HS+187, LAT, and LAT+187 treatments. Due to the dwarf size of hsfalq mutants, LAT treatment was performed on day 18 and HS at day 20. All treatments are compared with plants upon 44° C. HS. FIG. 15D shows fresh weight of 1 μM 1-aminocyclopropane-1-carboxylic acid (ACC)-treated wild-type plants. 5-day-old plants were transferred to 1 μM ACC containing plates, and 11-day-old plants were HS-treated at 44° C. for 30 min before recovery at 22° C. for 3 days (HS, HS+ACC). LAT: 9-day-old plants without and with ACC treatment (LAT, LAT+ACC) were primed for 3 h at 37° C. before incubation for 2 days at 22° C., and further heat stress of 44° C. was performed at day 11 for 30 min. FIG. 15E shows percent survival of Col-0 plants with and without ACC under HS, HS+ACC, LAT, and LAT+ACC conditions. FIG. 15F shows fresh weight of hsfa2 and control Col-0 plants treated with and without ACC under non-heat stress condition (NHS, NHS+ACC) of 22° C. and heat stress (HS, HS+ACC) condition of 44° C. for 30 min. Percent survival was scored at day 4 of recovery from 44° C. heat stress. All treatments were compared with plants upon HS. Data information: All plots represent the means of 3 biological replicates (n=36, 12 plants per biological repeat). Error bars represent SD of three biological repeats. Asterisks indicate a statistical difference based on Student's t-test (*P≤0.05; **P≤0.01; ***P≤0.001). FIG. 15G shows fresh weight of SA187-colonized or non-colonized ein2-1 mutant plants under control conditions (NHS). FIG. 15H shows percent survival of plants and (FIG. 151) Percent of bleached (grey) and green leaves (green) of plants with and without SA187 under HS and LAT treatments. Each treatment was compared to direct 44° C. heat stressed plants. FIG. 15J Fresh weight of non-HS plants without (NHS) and with SA187 (NHS+187) on day 15 at 22° C. All plots represent the mean of 3 biological replicates (n=36, 12 plants per repeat). Error bars represent SD. Asterisks indicate a statistical difference based on the Student's t-test (*P≤0.05; **P≤0.01; ***P≤0.001). FIG. 15K shows percent survival of hsfa2 plants with and without ACC. All treatments were compared with plants upon HS. All plots represent the means of 3 biological replicates (n=36, 12 plants per repeat). Error bars represent SD. Asterisks indicate a statistical difference based on the Student's t-test (*P≤0.05).

FIGS. 16A-16F the effect of SA187 on H3K4me3 levels at APX2 and HSP18.2 memory genes, one its dependence on ethylene and HSFA2 signaling. FIGS. 16A-16B show transcript levels of HS memory genes HSP18.2 and APX2 in ein3-1 non-heat-stressed (NHS, NHS+187), 44° C. heat-stressed SA187-colonized (HS+187), thermoprimed (LAT), and thermoprimed SA187-colonized plants (LAT+187) at 1, 24, 48, 72, and 96 h of recovery at 22° C. FIG. 16C shows relative enrichment of H3K4me3 at APX2 and HSP18.2 in control non-primed (NP), SA187-colonized non-primed plants (NP+187), 37° C.-primed (P), and 37° C. primed SA187-colonized plants (P+187) at 24 and 72 h after priming as determined by chromatin immunoprecipitation-qPCR for the indicated regions of APX2 and HSP18.2 (FIG. 14F). FIGS. 16D-16E show transcript levels of HS memory genes HSP18.2 and APX2 in hsfa2 mutant. FIG. 16F shows relative enrichment of H3K4me3 levels at APX2 and HSP18.2 memory genes in hsfa2 mutant. Data information: For transcript level analysis, the data were normalized to tubulin as reference gene and the respective 22° C. NHS, NHS+187 control plants, that were harvested at the same time points. For H3K4me3 enrichment analysis, amplification values were normalized to input and H3 and region 1 of non-primed (NP) plants. All treatments are compared with direct 44° C. HS treatment for statistical significance. All plots represent the means of 3 biological replicates. Error bars indicate SE. Asterisks indicate a statistical difference based on Student's t-test *P≤0.05; **P≤0.01; **P≤0.001 for differences between NP in comparison to NP+187, P, and P+187 treatments.

FIGS. 17A-17C show the effect of SA187 on wheat microbiome composition. FIG. 17A shows the principal component analysis (PCA) of microbiome samples from soil (S) and the endosphere of wheat roots without (R-mock) and with SA187 treatment (R-187). The first component (PC1) explains 67% of the total variance, while PC2 represents 10%. FIG. 17B shows relative percent abundance of bacterial phyla in the soil and the wheat root endosphere without (R-mock) and with SA187 treatment (R-187). FIG. 17C shows bacterial family abundance in the soil and the wheat root endosphere without (R-mock) and with SA187 (R-187). Data information: Microbiome analysis was performed in triplicates.

FIGS. 18A-18B show the effect of SA187 on wheat production under open-field agriculture. FIG. 18A shows meteorological data at ICBA (Dubai, UAE) during three growing seasons (2014-2015, 2016-2017, and 2017-2018). FIG. 18B shows quantitative measurements of wheat plant height, spike length, number of spikes/plant, number of seeds/plant, and weight of 1,000 grains collected from SA187-treated and non-treated wheat plants, and % of increase are indicated. Asterisks indicate a statistical difference based on the on Mann-Whitney test (*P<0.05). Error bars indicate SE. FIG. 18C shows seed yield of wheat obtained upon cultivation with and without SA187 in three consecutive growing seasons of open field agriculture. Error bars represent SE. Asterisks indicate a statistical difference based on the on Mann-Whitney test (P<0.05).

FIGS. 19A-19D show gene ontology analysis of differentially expressed genes. FIGS. 19A and 19B are histograms showing enriched GO terms for common DEGs (FIG. 19A) up- and (FIG. 19B) down-regulated genes in HS vs. NHS, LAT vs. NHS, HS+187 vs. NHS+187, LAT+187 vs. NHS+187. FIGS. 19C and 19D are histograms showing enriched GO terms for DEGs (C) up- and (D) down-regulated genes in LAT vs. HS-treated plants. Data information: RNA-seq experiments were performed in three biological replicates. 5-day-old seedlings+/−SA187 were transferred to new ½ MS plates before HS treatment. RNA-seq was performed with LAT: 9-day-old plants that were grown at 22° C. were treated for 3 h at 37° C. and then returned to 22° C. for 2 days. At day 11, plants were heat-stressed at 44° C. for 30 min and incubated for 4 day of recovery at 22° C. HS: 11-day-old plants that were grown at 22° C. were treated at 44° C. for 30 min and incubated for recovery at 22° C. for 4 day for RNA-seq. Non-HS (NHS): control plants were grown in parallel at 22° C. for 15 days.

FIG. 20 shows SA187-induced expression of heat-responsive genes. Heat-shock proteins (HSPs: HSP70b, HSP70, HSP90) and other heat-responsive genes (MIPS2, GA3OX1, XTR6, ATERDJ3A) show higher transcript levels with SA187 (HS+187) and thermopriming (LAT) in comparison to HS plants after exposure to 30 min of 44° C. HS after 1 h of recovery at 22° C. All plots represent the means of 3 biological replicates. Error bars represent SE. Asterisks indicate a statistical difference based on Student's t-test (*P≤0.05; **P≤0.01).

FIGS. 21A-21D show phenotype analysis of Col-0, hsfa2, hsfalq, and ein3-1 plants. FIG. 21A shows the fresh weight of SA187-colonized or non-colonized wild-type (Col-0), hsfa2, hsfalq, and ein3-1 mutant plants under control conditions at 22° C. (NHS). FIG. 21B-21D show bleaching (bottom) and green leaves (top) quantification in wild-type, hsfa2, and ein3-1 mutant plants in NHS, NHS+187, HS, HS+187, LAT, and LAT+187 plants (average of three biological repeats with 12 plants each biological repeat; n=36 plants). Due to dwarf and sick phenotype of hsfalq plants, numbers of bleached and green leaves were not scored. All treatments were compared with plants after direct 44° C. HS treatment. Data information: Plots represent the mean value of three biological replicates. Error bars represent SD. Asterisks indicate a statistical difference based on Student's t-test (*P≤0.05; **P≤0.01; ***P≤0.001).

FIG. 22 shows quantification of SA187-colonization in Col-0, ein3-1, and hsfa2 plants. Efficiency of colonization was evaluated by counting colony forming units (CFU) and normalized per mg of plant sample. For heat stress treatment, 10-day-old seedlings were heat-stressed at 44° C. for 30 min and samples were plated at control 0, 1, 24, and 48 h of 44° C. heat stress. All experiments were performed in triplicates. Error bars represent SE.

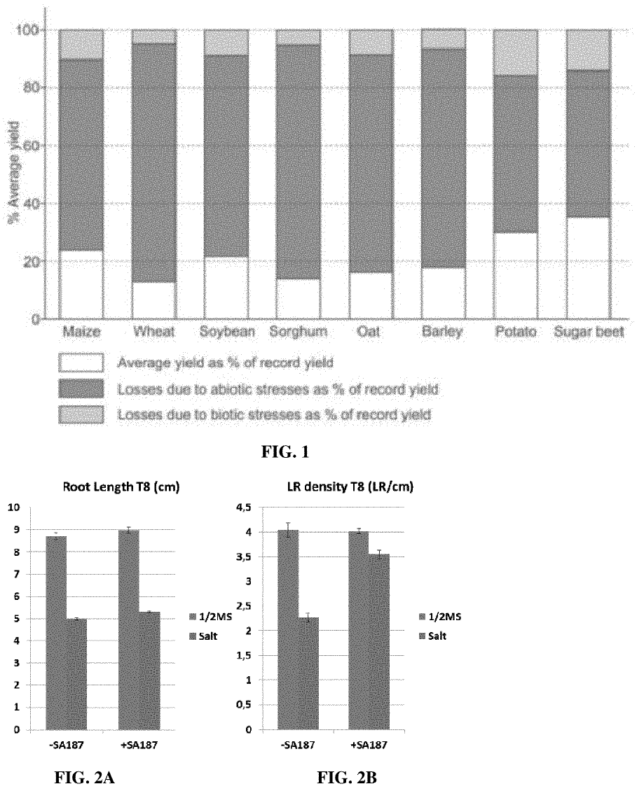

### DETAILED DESCRIPTION OF THE INVENTION

### I. Definitions

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The term “plant substrate” refers to a substrate commonly used for growing plants, including plant seeds, plant roots and plant seedlings. Non-limiting examples of such plant substrates include, but are not limited to soil, peat, compost, vermiculite, perlite, sand, clay, and combinations thereof.

“Plant growth-promoting rhizobacteria (PGPR)” refers soil bacteria that colonize the roots of plants following inoculation onto seed and that enhance plant growth (Kloepper, Joseph W.; Schroth, Milton N., Proceedings of the 4th International Conference on Plant Pathogenic Bacteria (Angers, France: Station de Pathologie Vegetale et Phytobacteriologie, INRA) 2: 879-882 (1978); Aziz, Z. F. A., et al, Malaysian Journal of Microbiology 8(1): 47-50 (2012)).

“Abiotic stress conditions” refer to conditions caused by non-living factors on the living organisms in a specific environment. Exemplary abiotic stress conditions include, but are not limited to drought, high heat, high salt, bright light, ultraviolet light, too high and too low temperatures, freezing, heavy metals and hypoxia. High salt concentrations typically refers to 100-300 mM salt (such as NaCl) or higher. Saline soil has an excess of soluble salt in the soil solution, the liquid located between aggregates of soil. A sodic soil has too much sodium associated with the negatively charged clay particles. Salinity occurs through natural or human-induced processes that result in the accumulation of dissolved salts in the soil water to an extent that inhibits plant growth. Natural salinity results from the accumulation of salts over long periods of time and is caused by two natural processes. The first is the weathering process that breaks down rock and release soluble salts of various type, mainly chloride of sodium, calcium and magnesium, and to a lesser extent, sulphates and carbonates. Sodium chloride is the most soluble salt. The second is the deposition of oceanic salt carried in wind and rain. Human-induced salinity results from human activity that change the hydrologic balance of the soil between water applied (irrigation or rainfall) and water used by crops (transpiration). The most common causes are (i) land clearing and the replacement of perennial vegetation with annual crops, and (ii) irrigation schemes using salt-rich irrigation water or having insufficient drainage (Roberto (2011). Soil Bacteria Support and Protect Plants Against Abiotic Stresses, Abiotic Stress in Plants—Mechanisms and Adaptations, Prof. Arun Shanker (Ed.), ISBN: 978-953-307-394-1, InTech, DOI: 10.5772/23310). With regard to heat, a transient elevation in temperature, usually 10-15° C. above ambient, is considered stress, but heat stress also depends on temperature intensity, duration of treatment and rate of temperature increase.

### II. Compositions for Promoting Abiotic Stress Resistance

Compositions containing SA187 are provided that can be used to provide seeds and plants with resistance or tolerance to abiotic stress conditions. SA187 was deposited on Sep. 24, 2019, with American Type Culture Collection (ATCC), P.O. Box 1549, Manassas, Va. 20110 USA, and given Patent Deposit Number PTA-126210.

Preferred seeds and plants, preferably roots that can be inoculated with or coated with SA187 include, but are not limited to alfalfa, cotton, wheat, maize, soybean, oat, barley, potato, and sugar beets.

One embodiment provides seeds or plants inoculated with an effective amount of SA187 to provide the seed or plant with resistance or tolerance to abiotic stress conditions. The seeds or plants can be coated with SA187. One embodiment provides a root of a plant coated with SA187.

A. SA187 Containing Plant Substrates

Rhizosphere microorganisms, particularly beneficial bacteria and fungi, can improve plant performance under stress environments and, consequently, enhance yield both directly and indirectly (Dimkpa, et al, Plant, Cell and Environment, 32 1682-1694 (2009)). Some plant growth-promoting rhizobacteria (PGPR) may exert a direct stimulation on plant growth and development by providing plants with fixed nitrogen, phytohormones, iron that has been sequestered by bacterial siderophores, and soluble phosphate (Hayat, et al, Annals of Microbiology, 60 579-598 (2010)). Others do this indirectly by protecting the plant against soil-borne diseases, most of which are caused by pathogenic fungi (Lutgtenberg et al, Annual Review of Microbiology, 63 541 556 (2009)). Bacteria of diverse genera such as Arthrobacter, Azotobacter, Azospirillum, Bacillus, Enterobacter, Pseudomonas and Serratia (Gray, et al., Soil Biology & Biochemistry, 37 395 412 (2005)), as well as Streptomyces spp. (Dimkpa, et al., Canadian Journal of Microbiology, 54: 163 172 (2008)) have been identified as PGPR and can be combined with SA187 in the disclosed compositions.

One embodiment provides a plant substrate containing an effective amount of a species of the genus Enterobacter to inhibit or reduce abiotic stress in the plant. In a preferred embodiment, the Enterobacter species is SA187. Suitable plant substrates include, but are not limited to soil, peat, compost, vermiculite, perlite, sand, clay and combinations thereof. Typically, the plant substrates contain 10⁶ to 10⁹ bacteria per/g of substrate.

B. Co-Inoculation

Plants and seeds can be co-inoculated with SA187 and one or more other plant growth-promoting bacteria or rhizobacteria to provide the seeds or plants with resistance or tolerance to abiotic stress conditions. Co-inoculation is based on mixed inoculants, combination of microorganisms that interact synergistically, or when microorganisms such as Azospirillum are functioning as “helper” bacteria to enhance the performance of other beneficial microorganisms. In the rhizosphere the synergism between various bacterial genera such as Bacillus, Pseudomonas and Rhizobium has been demonstrated to promote plant growth and development. Compared to single inoculation, co-inoculation can improve the absorption of nitrogen, phosphorus and mineral nutrients by plants.

Suitable bacteria that can be co-inoculated with SA187 include but are not limited to Pseudomonas putida, Pseudomonas aeruginosa, Klebsiella sp., Enterobacter asburiae, Rhizobium sp. (pea), Mesorhizobium sp., Acinetobacter spp., Rhizobium sp. (lentil), Pseudomonas sp. A3R3, Psychrobacter sp. SRS8, Bradyrhizobium sp., Pseudomonas aeruginosa 4EA, Pseudomonas sp., Ochrobactrum cytisi, Bacillus species PSB10, Paenibacillus polymyxa, Rhizobium phaseoli, Rahnella aquatilis, Pseudomonas fluorescens, Ralstonia metallidurans, Azospirillum amazonense, Serratia marcescens, Enterobacter sp., Burkholderia, Pseudomonas jessenii, Azotobacter sp., Mesorhizobium ciceri, Azotobacter chroococcum, Klebsiella oxytoca, Pseudomonas chlororaphis, Bacillus subtilis, Gluconacetobacter, diazotrophicus, Brevibacillus spp., Bravibacterium sp., Xanthomonas sp. RJ3, Azomonas sp. RJ4, Pseudomonas sp. RJ10, Bacillus sp. RJ31, Bradyrhizobium japonicum, Variovorax paradoxus, Rhodococcus sp., Flavobacterium, Sphingomonas sp, Mycobacterium sp, Rhodococcus sp, Cellulomonas sp., Azospirillum sp., Azospirillum brasilense, Rhizobium meliloti, Kluyvera ascorbata, Rhizobium cicero, Rhizobium leguminosarum, Paenibacillus polymyxa strain A26, a Alcaligenes faecalis strain AF, and combinations thereof.

Additional bacteria that can be inoculated with SA187 and exemplary plants that can be inoculated include those listed in Table 1.

TABLE 1
Bacterial Inoculates for Abiotic Stress (From Bianco
Carmen and Defez Roberto (2011). Soil Bacteria Support
and Protect Plants Against Abiotic Stresses, Abiotic Stress in
Plants—Mechanisms and Adaptations, Prof. Arun
Shanker (Ed.), ISBN: 978-953-307-394-1,
InTech, DOI: 10.5772/23310)

| Stress type | Bacterial inoculate | Plant Species |
|---|---|---|
| Salt | Pseudomonas | Rice (Oryza sativa) |
| | pseudoalcaligenes, | |
| | Bacillus purnilus | |
| Salt | Bacillus megateriurn | Maize (Zea maize L.) |
| Salt | Azospirillurn brasilense | Barley (Hordeum vulgare) |
| Salt | Pseudomonas mendocina | Lettuce (L. sativa L. cv. |
| | | Tafalla) |
| Salt | Azospirillurn sp. | Pea (Phaseolus vulgaris) |
| Salt | Bacillus subtilis | Arabidopsis thaliana |
| Salt | Pseudomonas syringae, | Maize (Zea maize) |
| | Pseudomonas fluorescens, | |
| | Enterobacter aerogenes | |
| Salt | P. fluorescens | Groundnut (Arachis |
| | | hypogaea) |
| Salt | Azospirillurn | Lettuce (Lactuca sativa) |
| Salt | Achrornobacter piechaudii | Tomato (Lycopersicon |
| | | esculentum) |
| Salt | Aeromonas | Wheat (Triticum aestivum) |
| | hydrophila/caviae | |
| | Bacillus insolitus, Bacillus | |
| | sp. | |
| Salt | Azospirillum | Maize (Z. maize) |
| Salt | A. brasilense | Chickpeas (Cicer arietinum), |
| | | faba beans (Vicia faba L.) |
| Drought | Pseudomonas spp. | Maize (Zea mays L. cv. |
| | | Kaveri) |
| Drought | Pseudomonas spp. | Asparagus (Asparagus |
| | | officinalis L.) |
| Drought | Pseudomonas mendocina | Lettuce (Lactuca sativa L.) |
| Drought | Rhizobium tropici, | Common bean (Phaseolus |
| | Paenibacillus polymyxa | vulgaris L.) |
| Drought | Bacillus | Lettuce (Lactuca sativa L.) |
| Drought | Ensifer meliloti by. | Bean (Phaseolus vulgaris cv. |
| | mediterranense | Flamingo) |
| Drought | Bradyrhizobium elkanii | Flat crown (Albizia |
| | | adianthifolia) |
| Drought | Achromobacter piechaudii | Tomato (L. esculentum), |
| | | pepper (Capsicum annuum) |
| Drought | Azospirillum | Wheat (T. aestivum) |
| Drought | A. brasilense | Maize (Z. mays) |
| Drought | A. brasilense | Common bean (P. vulgaris) |
| Osmotic stress | Bacillus subtilis | Arabidopsis |
| Osmotic stress | A. brasilense | Rice (Oryza sativa L.) |
| Osmotic stress | Arthrobacter sp., Bacillus | Pepper (C. annuum) |
| (45% PEG) | sp. | |
| Osmotic stress | Azospirillum | Wheat (T. aestivum) |
| (20% PEG) | | |
| Flooding | Enterobacter cloacae, | Tomato (L. esculentum) |
| | Pseudomonas putida | |
| Temperature | Burkholderia phytofirmans | Grapevine (Vitis vinifera) |
| Temerature | Pseudomonas fluorescens, | Wheat (Triticum aestivum) |
| | Pantoea agglomerans, | |
| | Mycobacterium sp. | |
| Temperature | B. phytofirmans | Potato (Solanum tuberosum) |
| Temperature | Aeromonas hydrophila, | Soy bean (Glycine max) |
| | Serratia liquefaciens, | |
| | Serratia proteamaculans | |
| Temperature | Burkholderia phytofirmans | Grapevine (Vitis vinifera) |
| Temperature | B. phytofirmans | Potato (Solanum tuberosum) |
| Temperature | Aeromonas hydrophila, | Soy bean (Glycine max) |
| | Serratia liquefaciens, | |
| | Serratia proteamaculans | |
| Nutrient | Azospirillum sp., | Chickpea (Cicer arietinum |
| deficiency | Azotobacter chroococcum, | L.) |
| | Mesorhizobium ciceri, | |
| | Pseudomonas fluorescens | |
| Nutrient | Azotobacter coroocoocum, | Zea maize L. (Zea maize L.) |
| deficiency | Azospirillum brasilens, | |
| | Pseudomonas putida, | |
| | Bacillus lentus | |
| Nutrient | Bacillus sp., | Zea maize L. |
| deficiency | Burkholderia sp., | |
| | Streptomyces platensis | |
| Nutrient | Bacillus sp., | Zea maize L. |
| deficiency | | |
| Nutrient | Bacillus polymyxa, | Zea maize L. (Zea maize cv. |
| deficiency | Mycobacterium phlei, | Felix) |
| | Pseudomonas alcaligenes | |
| Heavy metals | Sanguibacter sp., | Nicotina tabacum |
| toxicity | Pseudomonas sp. | |
| Heavy metals | Bacillus subtilis, | Oat (Avena sativa) |
| toxicity | Pantoea agglomerans | |
| Heavy metals | Pseudomonas fluorescens, | Rape (Brassica napus) |
| toxicity | Microbacterium sp. | |
| Heavy metals | Methylobacterium oryzae, | Tomato (Lycopersicon |
| toxicity | Burkholderia sp. | esculentum L.) |
| Heavy metals | Bacillus subtilis, | Rice (O. sativa) |
| toxicity | Bacillus megaterium, | |
| | Bacillus sp. | |

C. Seed Coating Compositions

One embodiment provides a seed coating composition having at least one layer coating all or part of the seed, wherein at least one layer contains an effective amount of SA187 to provide the seed or the plant that grows from the seed with resistance to abiotic stress conditions. The SA187 can be from 10⁶/ml to 10⁹/ml of seed coating composition.

Another embodiment provides a seed coating composition containing SA187. The SA187 can be encapsulated with a non-toxic, biodegradable coating. The seed coating composition can also contain a coating adhesive. Exemplary seed coating compositions contain gelatin, cellulose, alginate, xanthum, or a combination thereof. Certain seed coating compositions can have multiple layers.

In another embodiment, the seed coating composition contains multiple layers for example, 2, 3, 4 or 5 or more layers. SA187 and/or one or more additional plant growth promoting bacteria can be in any or all of the layers of the seed coating composition; however, at least one of the layers of a multiple layer seed coating composition contains an effective amount of SA187 to provide the seed or the plant growing from the seed with resistance to abiotic stress conditions. Preferably, the SA187 or other plant growth promoting bacteria are in the layer adjacent to the surface of the seed.

In one embodiment, at least one layer contains guar gum, derivative guar, polyacrylamide, poly(methacrylic acid), poly(acrylic acid), polyacrylate, poly(ethylene glycol), phosphonate-end capped polymers, polyethyleneoxide, poly(vinyl alcohol), polyglycerol, polytetrahydrofuran, polyamide, hydroxypropyl guar, carboxymethyl guar, carboxymethyl hydroxypropyl guar, starch, derivatized (e.g., cationic) starch, corn starch, wheat starch, rice starch, potato starch, tapioca, waxy maize, sorghum, waxy sarghum, sago, dextrin, chitin, chitosan, alginate compositions, xanthan gum, carageenan gum, gum karaya, gum arabic, pectin, cellulose, hydroxycellulose, hydroxyalkyl cellulose, hydroxyethyl cellulose, carboxymethylhydroxyethyl cellulose, hydroxypropyl cellulose, a derivative of any of the foregoing or a combination of any of the foregoing. As non-limiting examples, the layer can contain a 90 wt % derivatized guar and 10 wt % starch (or derivatized starch) mixture, or a 60 wt % hydroxypropyl guar and 40 wt % carboxymethyl hydroxypropyl guar mixture.

In some embodiments, the layer can act as a carrier coating. Fungicides and beneficial microbes that protect the seed and emerging seedling are carried in the carrier coating. For example, alfalfa seed coating with incorporated SA187 is used to inoculate the field in which desired crop plants are planted or are growing.

Another embodiment provides agglomerates of seed. The agglomerate or grouping of seed is a grouping of 2 or more individual seeds together. The seeds can be for the same plant or for different plants. In another embodiment, the agglomerate is a grouping of more than 5 individual seeds together. In a further embodiment, the agglomerate is a grouping of more than 10 individual seeds together. In yet another embodiment, the agglomerate is a grouping of more than 25 individual seeds together. In yet a further embodiment, the agglomerate is a grouping of more than 50 individual seeds together. In another embodiment, the agglomerate is a grouping of more than 100 individual seeds together.

1. Seed Agglomerates

The agglomeration of seed can aid in the application of the seed coating composition because the seed coating composition, when using an agglomeration of seed, can be shaped or formed to be consistent in shape or form. For example, the agglomeration can be formed as spherical or substantially spherical, thus allowing the seed coating composition to be likewise substantially spherical. This can allow for improved or more consistent casting or spraying, can minimize the occurrence of blockage or clogging of the nozzles, hoses, etc. due to uneven particle size distribution. Typically, a binder or adhesive is utilized to bunch (e.g., agglomerize) the grouping of seeds together.

The agglomeration can also aid in seed or seedling establishment as a layer of the wetting agent (or other layer than affects the soil) can be concentrated to a local area of soil, thus, increasing its chance of wetting the soil surrounding the seed(s). the agglomeration can also promote survival by allowing the seeds, when germinating into seedlings, to generate sufficient force to penetrate hydrophobic areas or soil such as, for example, a hydrophobic (i.e., encrusted) soil surface

In one embodiment, the seed coating composition contains an agglomeration of seeds of from between 2 seeds to 100 seeds, typically between 2 to 50 seeds, typically between 2 to 25 seeds; and at least one layer selected from the group consisting of a layer of a filler, a layer of a binding agent, a layer of a wetting agent, a layer of an anti-bacteria agent, a layer of an active ingredient and any combination thereof.

In one embodiment, the seed coating composition is of substantially uniform size of from between 10 micrometers and 4 mm in diameter. In another embodiment, the seed coating composition is of substantially uniform size of from between 25 micrometers and 2 mm in diameter. In a further, the seed coating composition is of substantially uniform size of from between 500 micrometers and 2 mm in diameter.

2. Binder

The seed coating composition can also contain a binder as one of the layers, the binder is sometimes referred to as an adhesive. In one embodiment, the binder can include but is not limited to molasses, granulated sugar, alginates, karaya gum, guar gum, tragacanth gum, polysaccharide gum, mucilage or any combination of the foregoing. In another embodiment, the binder is chosen from, but is not limited to, gelatin, polyvinyl acetates, polyvinyl acetate copolymers, polyvinyl alcohols, polyvinyl alcohol copolymers, celluloses (including ethylcelluloses and methylcelluloses, hydroxypropylcelluloses, hydroxymethyl celluloses, hydroxymethylpropyl-celluloses), polyvinylpyrolidones, dextrins, malto-dextrins, polysaccharides, fats, oils, proteins, gum arables, shellacs, vinylidene chloride, vinylidene chloride copolymers, calcium lignosulfonates, acrylic copolymers, starches, polyvinylacrylates, zeins, carboxymethylcellulose, chitosan, polyethylene oxide, acrylimide polymers and copolymers, polyhydroxyethyl acrylate, methylacrylimide monomers, alginate, ethylcellulose, polychloroprene, syrups or any combination of the foregoing.

3. Active Ingredients

The seed coating compositions can also include one or more active ingredients in one or more of the layers of the coating. Compounds suitable as active ingredients, which in some embodiments form all or part of at least one layer of the seed coating composition, include but are not limited to herbicides, plant growth regulators, crop desiccants, fungicides, insecticides, insect repellants, and combinations thereof. Suitable pesticides include, for example, triazine herbicides; sulfonylurea herbicides; uracils; urea herbicides; acetanilide herbicides; and organophosphonate herbicides such as glyphosate salts and esters. Suitable fungicides include, for example, nitrilo oxime fungicides; imidazole fungicides; triazole fungicides; sulfenamide fungicides; dithio-carbamate fungicides; chloronated aromatic; and dichloro aniline fungicides. Suitable insecticides, include, for example, carbamate insecticides; organo thiophosphate insecticides; and perchlorinated organic insecticides such as methoxychlor. Suitable miticides include, for example, propynyl sulfite; triazapentadiene miticides; chlorinated aromatic miticides such as tetradifan; and dinitrophenol miticides such as binapacryl. Other active ingredients can include adjuvants, surfactants, and fertilizers.

4. Filler

The seed coating composition can also include at least one filler as all or part of a layer. In one embodiment, the filler is selected from the group consisting of wood flours, clays, activated carbon, carbohydrates, sugars, dextrins, maltodextrins, diatomaceous earth, cereal flours, wheat flour, oat flour, barley flour, fine-grain inorganic solids, calcium carbonate, calcium bentonite, kaolin, china clay, talc, perlite, mica, vermiculite, silicas, quartz powder, montmorillonite or mixtures thereof.

5. Nutrients

The seed coating composition can also contain a nutrient such as a micronutrient or macronutrient in one or more layers of the seed coating composition. The nutrient can be in all or part of a layer. The nutrient can also be included with the grouping of seeds as part of the binder or adhesive. “Nutrient” as used herein can refer to an additive or substance utilized by plants, grasses, shrubs for plant, grass, and shrub growth, respectively. Macronutrients can be utilized in larger amounts by plants, grasses, etc. in proportionally larger amounts relative to micronutrients. Nutrients include but are not limited to manganese, boron, copper, iron, chlorine, molybdenum, and zinc, potassium, nitrogen, calcium, magnesium phosphorus and sulfur, among others. The seed coating compositions can include various combinations and relative amounts of individual macronutrients.

D. Coating Techniques

Equipment utilized to for coating seeds with the disclosed seed coating compositions include, but are not limited to drum coaters, rotary coaters, tumbling drums, fluidized beds and spouted beds to name a few. The seeds can be coated via a batch or continuous coating process.

The seeds can be separated prior to coating which, in one embodiment, utilizes mechanical means such as a sieve. The separated seeds can then be introduced into a coating machine having a seed reservoir. In one embodiment, the seeds in the mixing bowl are combined with one or more of the coatings described herein and adhered with a binder or adhesive.

In one embodiment of the process, one or more layers as described herein can be added to coat the seed or agglomeration. Outer layers can be introduced sequentially to the rotating drum.

In another embodiment, agglomerators or agglomerator devices may also be utilized. Coating is performed within a rotary coater by placing seeds within a rotating chamber, which pushes the seeds against the inside wall of the chamber. Centrifugal forces and mixing bars placed inside the coater allow the seed to rotate and mix with a coating layer. Binder or other coating materials can be pumped into the proximate center of the coater onto an atomizer disk that rotates along with the coating chamber. Upon hitting the atomizer disk, liquid adhesive is then directed outward in small drops onto the seed.

In one embodiment, seed coating techniques include, for example, seed in a rotating pan or drum. Seed is then misted with water or other liquid and then gradually a fine inert powder, e.g., Diatomaceous earth, is added to the coating pan. Each misted seed becomes the center of a mass of powder, layers, or coatings that gradually increases in size. The mass is then rounded and smoothed by the tumbling action in the pan, similar to pebbles on the beach. The coating layers are compacted by compression from the weight of material in the pan. Binders often are incorporated near the end of the coating process to harden the outer layer of the mass. Binders can also reduce the amount of dust produced by the finished product in handling, shipping and sowing. Screening techniques, such as frequent hand screening, are often times utilized to eliminate blanks or doubles, and to ensure uniform size. For example, tolerance for seed coating compositions described herein can be about 1/64th inch (0.4 mm), which is the US seed trade standard for sizing.

In yet another embodiment, the seed coating compositions and methods described herein comprises “in situ coating”. In situ coating means, in one embodiment, where a raw or non-coated seed is implanted in a hole, cavity or hollowed area in the ground and immediately or soon thereafter a coating composition is sprayed or applied directly into the hole, cavity or hollowed area to surround or partially surround the seed. Typically, the application of the seed as well as application of the coating composition are performed mechanically but is understood that either or both of the referenced applications can be performed manually as well.

The coating can also be applied to a seed by spraying, dipping or brushing.

### III. Methods for Providing Tolerance or Resistance to Abiotic Stress Conditions

Methods for providing seeds and plants with resistance or tolerance to abiotic stress conditions such as heat stress, are provided. Plants grown under temperatures 5-30° C. above ambient, preferably, between 10 and 20° C., and more preferably, between 10 and 15° C. above ambient for the particular plant being cultivated, are considered to be under heat stress. Most plants grow best in temperature ranges 59-86F. When temperatures above 90 F are sustained for long periods, plant growth is slowed, and some plants begin to show signs of stress. Above 104 F, many plants will survive but will show different signs of heat stress dependent on plant type, maturity of the plant, and factors that often come with high temperatures, such as drought or wind, Extreme air and soil temperatures slow down chemical activity and growth in plants.

Generally, heat stress of a plant will show itself by wilting, which is a sure sign that water loss has taken place. Heat stress of a plant can also be recognized by, leaf drop, especially in trees. Many plants will actually shed some of their foliage in an attempt to conserve water. in excessively hot weather, many vegetable crops have difficulty producing. Plants like tomatoes, squash, peppers, melons, cucumbers, pumpkins, and beans will usually drop their blossoms in high temps, while cool-season crops like broccoli, will bolt. Bolting is the premature flowering of plants before they would typically be harvested. High temperatures induce bolting in cool-season vegetables. A heatwave will likely mean the end for many cool weather plants like cilantro, broccoli, cauliflower, lettuce, and spinach, Blossom end rot is also common during hot weather and most prevalent in tomatoes, peppers, and squash.

In order to cope with heat stress(HS), plants have developed several strategies such as basal heat tolerance and acquired heat tolerance. In basal heat tolerance, plants have a natural capacity to deal with heat stress, whereas in acquired thermotolerance, called heat acclimation or thermopriming, plants acquire tolerance to lethal levels via a short pre-exposure to a mild HS, a phenomenon that is known as priming (Yeh et al, 2012). Depending on the recovery time before the secondary acute heat stress exposure, acquired thermotolerance is distinguished between “short-term acquired thermotolerance” (SAT) and “long-term acquired thermotolerance” (LAT). Acquired thermotolerance establishes a molecular stress memory state that helps to protect plants from acute heat stress damage and cell death (Sani et al, 2013). Thermopriming is responsible for the higher expression of HS transcription factors (HSFs) regulating the expression of heat-shock proteins (HSPs) and antioxidant genes, which are responsible for responding robustly and quickly to the exposure and subsequent recovery from HS (Conrath et al, 2006; Hilker et al, 2016; Lin et al, 2018). Heat-shock factor-A2 (HSFA2) is required for the active memory of HS in plants (Charng et al, 2007; Scharf et al, 2012). The expression of HSFA2 is regulated by the four transcription factorsHSFA1A, B, D, and E, which activate the expression of HSFA2. In turn, HSFA2 amplifies the transcriptional induction of a subset of HS response and memory genes (Mishra et al, 2002; Schramm et al, 2006; Liu et al, 2011; Yoshida et al, 2011; Yeh et al, 2012; Liu & Charng, 2013; Stief et al, 2014). HSFA2 binds transiently in a hit and run mode at the promoter region of HS memory genes, thereby facilitating di- and trimethylation of lysine 4 on histone H3 (H3K4me2, H3K4me3) (Lämke et al, 2016a). Thermopriming-induced chromatin modification at the APX2 and HSP18.2 heat stress memory genes induces a transcriptional memory that leads to transcriptional hyper-activation upon a recurring heat stress (Bruce et al, 2007; Vriet et al, 2015; Lämke et al, 2016b; Lämke & Báurle, 2017).

Thermopriming could be applied in agriculture to make crops more heat stress resistant and productive (Liu & Charng, 2012), but its application is not feasible under field conditions. In this context, the use of beneficial root endophytes and rhizobacteria (known as plant growth-promoting bacteria, PGPB) might be a more reliable method to promote plant growth under abiotic stress conditions(Márquez et al, 2007; de Zélicourt et al, 2018; Numan et al, 2018; Saad et al, 2020). Here, the studies report that the root endophytic bacterium Enterobacter sp. SA187, isolated from root nodules of the indigenous desert plant Indigofera argentea (Andrés-Barrao et al, 2017), significantly enhances thermotolerance in wheat under laboratory and field conditions without significantly affecting the endogenous microbiome composition. In Arabidopsis, SA187 regulates the transcription dynamics of selected heat stress memory genes by hypermethylation of histone H3K4. Thermoprimed heat tolerance depends on the transcription factors HSFA1A, B, D, and E and the downstream master regulator HSF2A (Lämke et al, 2016b; L€amke & Báurle, 2017). Whereas thermopriming and root endophyte-induced thermotolerance both depend on HSFA2, SA187functions independently of HSFA1A, B, D, and E.

SA187-induced thermotolerance acts on HSFA2 via the ethylene signaling pathway and the transcription factor EIN3

The methods include inoculating the seed or plant with an effective amount (10⁶-10⁸ bacteria/ml) of SA187 (alone or in combination with adding ACC (1-aminocyclopropane-1-carboxylic acid)) to provide the seed or plant with resistance to the abiotic stress conditions. In one embodiment, seeds are coated with a mixture containing broth culture, sugar solution (10%) with a rate of 2×10⁹ cell/kg seed. The inoculated seeds were kept for 1 h, and thereafter, the seeds are air-dried over 3 MM filter paper (Whatman) and sown immediately. The inoculation of the plant can be in the rhizosphere of the plant. The rhizosphere is the area around a plant root that is inhabited by a unique population of microorganisms. In some embodiments the method is a plant tissue culture, and the method includes adding ACC (1-aminocyclopropane-1-carboxylic acid) and/or an effective amount of SA187 to the plant culture

Alternatively, the plant root can be inoculated directly. In certain embodiments, the plant root is coated with SA187.

A method for providing a seed or plant with resistance to abiotic stress condition include coating the seed or a root of the plant with an effective amount of SA187 to provide the seed or plant with resistance or tolerance to abiotic stress conditions.

Yet another embodiment provides a method of improving growth of a seed or plant under abiotic stress conditions by growing the seed or plant in a plant substrate, wherein the plant substrate includes an effective amount of SA187 to colonize the seed or a root of the plant to provide abiotic stress resistance to the seed or plant.

Still another embodiment provides a method of improving tolerance of a seed or plant against abiotic stress conditions by growing the seed or plant in a plant substrate comprising an effective amount of SA187 to provide the seed or plant with tolerance to the abiotic stress conditions.

Yet another embodiment provides a method of providing a plant with abiotic stress resistance by inoculating the plant's rhizosphere with SA187.

One embodiment provides a method for increasing crop yield or crop biomass by inoculating fallow soil with SA187, planting crop seeds or crop seedlings into the inoculated fallow soil, cultivating the crop seeds or crop seedlings into mature plants, and harvesting the mature plants, wherein the harvested mature plants have increased crop yield or crop biomass or both, relative to similar crop seeds or crop seedlings cultivated in soil without SA187.

Another embodiment provides a method for increasing crop yield or crop biomass by inoculating roots of crop plants with SA187 to increase crop yield or crop biomass or both relative to crop plants grown without SA187. The crop plants can be grown in a field, pasture, land, farmland, or in gardens. Crops that can be treated with SA187 include but are not limited to alfalfa, cotton, wheat, maize, soybean, oat, barley, potato, and sugar beets.

### EXAMPLES

### Example 1: Identification of SA187

Methods

Organisms

Enterobacter sp. SA187 is endophytic bacteria isolated from surface sterilized root nodules formed on roots of pioneer plant Indigofera argentea Burm. f. (Fabaceae). Plants were collected from different regions in the Jizan area (16° 56.475′ N, 42° 36.694′ E) of Saudi Arabia. SA187 has been shown to possess plant growth promoting activities, such as the production of siderophores and indole acetic acid (IAA).

Sequencing

The genomic DNA of SA187 was extracted using the Qiagen's DNeasy blood and tissue kit following the manufacturer protocol. The DNA was then sequenced using paired-end Illumina MiSeq and the library preparation was constructed as described previously (1). Contig assembly was done with Spades assembler version 3.6 (4) with a 1 KB contig 52 cutoff size. Total RNA was extracted from 5-day-old plants inoculated or not with SA187 and transferred for 10 more days on ½ MS plates with or without 100 mM NaCl using the Nucleospin RNA plant kit (Macherey-Nagel), including DNase treatment, and following manufacturer's recommendations. RNA samples were used for Illumina HiSeq deep sequencing (Illumina HiSeq 2000, Illumina). Three biological replicates were processed for each sample. Paired-end sequencing of RNA-seq samples was performed using Illumina GAIIx with a read length of 100 bp. Reads were quality-controlled using F ASTQC (http://www. bioinformatics.babraham.ac.uk/projects/fastqc/). Trimmomatic was used for quality trimming8. Parameters for read quality filtering were set as follows: Minimum length of 36 bp; Mean Phred quality score greater than 30; Leading and trailing bases removal with base quality below 3; Sliding window of 4: 15. TopHat v2.0.99 was utilized for alignment of short reads to the Arabidopsis thaliana genome TAIR1 0 ( ) Cufflinks v2.2.010 for transcript assembly and differential expression. To identify differentially expressed genes, specific parameters (p-value: 0.05; statistical correction: Benjamini Hochberg; FDR: 0.05) in cuffdiff were used.

Post-processing and visualization of differential expression were done using cummeRbund v2.0.0u. Gene is considered as regulated if fold change>log 2|0 6′ and </−value<0.05. Results were confirmed by analyzing 12 genes using qPCR method.

For qPCR analysis, plant RNAs were purified as described previously.

For bacterium, SA187 incubated 4 h in ½MS or ½MS+100 mM, at 28° C., under the dark, were used for RNA extraction, using the RiboPure™ RNA Purification Kit, bacteria (Ambion) following manual instructions for Gram-(−) bacteria, with the exception that no beads were used during bacterial lysis. RNA extraction was followed by DNAsel treatment in order to obtain purified total RNA.

cDNAs were synthetized using SuperscriptIII (Invitrogen), 1 μg of total RNA and oligo-dT following manufacturer's recommendations. For Arabidopsis gene expression analyses, ACTIN2 (At3g18780) and UBIQUITIN10 (At4g05320) were used as reference genes. For SA187 gene expression analyses, infB, rpoB and gyrB were used as reference genes. All reactions were done in a CFX96 Touch™ Real-Time PCR Detection System (BIO-RAD) as follows: 50° C. for 2 mm, 95° C. for 10 mm; 40×[95° C. for 10 sec and 60° C. for 40 sec]; and a dissociation step to validate the PCR products. All reactions were performed in three biological replicates, and each reaction as a technical triplicate. Gene expression levels were calculated using Bio-Rad CFX manager software.

Hierarchical Clustering and Gene Family Enrichment

Arabidopsis regulated genes were used to generate HCL tree using Multi Experiment Viewer (MeV 4.9.0 version, TM4, https://sourceforge.net/projects/mev-tm4/files/mev-tm4/Me V %204.9.0/). Raw data were normalized for every gene and transformed in log 2. Hierarchical clustering was performed using Euclidian distances, average linkage and leaf order optimization. Heat colors indicate log 2 fold change. Gene enrichment analyses were performed using AmiGO website (http://amigol .geneontology.org/cgi-bin/amigo/term_enrichment). Each cluster were analyzed using default parameter.

Results

De novo assembly of MiSeq reads for Enterobacter sp. SA187 resulted in 14 contigs with a total length of 4,404,403 bp and a mean contig size of 314,600 bp. The N50 was 2,296,004 bp and the L50 has been reached in 1 contig. The GC content of this draft genome was 56%. Megablast (5) comparison of the SA187 concatenated contigs against the NCBI reference genome database (http://www.ncbi.nlm.nih.gov/genome/) revealed the 57 closest relative genomes being Enterobacter sacchari SP1 with a coverage of 63% and sequence identity of 95% (Accession number NZ_CP007215.2) (6). The annotation of Enterobacter sp. SA187 was carried out using the default INDIGO pipeline (7) with the exception of open reading frame (ORFs) prediction by FragGeneScan (8). The annotation of SA187 resulted in 3,087 ORFs, 9 rRNA, 75 tRNA, and 145 ncRNA.

The annotation predicted a number of siderophore pathway genes such as entE, entC, entA, entB, entF, as well as entS, an MFS transporter of enterobactin. An ABC transporter involved in iron uptake, sitABCD, was also found, as well as five copies of the iron complex outer membrane receptor (huA) and a TonB-dependent outer membrane iron-enterobactin/colicin (fepA). Generally, PGPR bacteria enhance plant growth through the synthesis of IAA from tryptophan via indole pyruvate as the main pathway (9). The SA187 genome harbors a number of genes involved in this pathway but lacks the gene encoding for indole pyruvate decarboxylase (ipdC). Moreover, the SA187 genome codes for the enzyme tryptophanase (TnaA) (EC: 4.1.99.1), which can transform tryptophane into indole.

### Example 2: Nucleotide Sequence Accession Numbers

Genome of Enterobacter sp. SA187 was deposited at DB J/EMBL/GenBank under accession number MORB00000000 (which is incorporated herein in its entirety. The genome of SA187 contains SEQ ID NO: 1-13 as disclosed in U.S. Ser. No. 16/072,137 (incorporated herein by reference).

Results

Based on 16S rDNA sequencing and comparison, SA187 was suggested to belong to the Enterobacter genus, with high homology with Enterobacter kobei strains.

The 16S ribosomal RNA gene sequence (or 16S rRNA) is deposited at DDB J/EMBL/GenBank under the accession no KYI 94757.

Based on the 16S rRNA gene sequence the SA187 is closely related to Enterobacter kobei CCUG 49023 T and Enterobacter aerogenes strain KCTC 2190 with 99% sequence similarity. One embodiment provides a bacterium comprising SEQ ID NO: 1, 2, 3, 4, 5, 6, 7, 8, 9, 10, 11, 12, 13 as disclosed in U.S. Ser. No. 16/072,137, or a combination thereof.

### Example 3: Salt Tolerance on Arabidopsis thaliana

Materials and Methods

SA187 was first tested in vitro on Arabidopsis thaliana plants.

Arabidopsis thaliana Columbia-0 ecotype have been germinated on ½ strength MS medium plates, a generic synthetic plant growth medium (adapted from Murashige and Skoog, 1962), containing 10 bacterial cells per plate, control plants were grown on regular ½ MS plates. After 5 days of germination, seedlings were transferred on 2 different medium: ½ MS (control condition), ½ MS+100 mM NaCl (Salt condition).

Arabidopsis thaliana Columbia-0 seeds were surface sterilized 10 min in 70% EtOH+0.05% Sodium Dodecyl Sulfate on a shaker, washed 2 times in 96% EtOH and let to dry. Sterilized seeds were sawn on ½ MS plates (Murashige and Skoog basal salts, Sigma) containing 2·105 cfu mL″1 (+SA187), stratified for 2 days at 4° C. in the dark and then placed vertically for germination for 5 days. Calculated amount of bacterial suspension was added to pre-cooled agar medium during plate preparation.

Germination was considered as occurring when a radicle was detectable under the stereomicroscope. Average length of root hairs was determined based on images of 5 day-old roots (1 image per root at constant distance from the root tip, 25 seedlings per condition) captured using a Nikon AZ100M microscope equipped with an AZ Plan Apo 2× objective and a DS-Ril camera (Nikon). All root hairs in focus were measured in ImageJ (https://imagej.nih.gov/ij/), average value and standard deviation were calculated from 10% longest root hairs to eliminate non-developed root hairs and describe the maximal elongation capacity of root hairs.

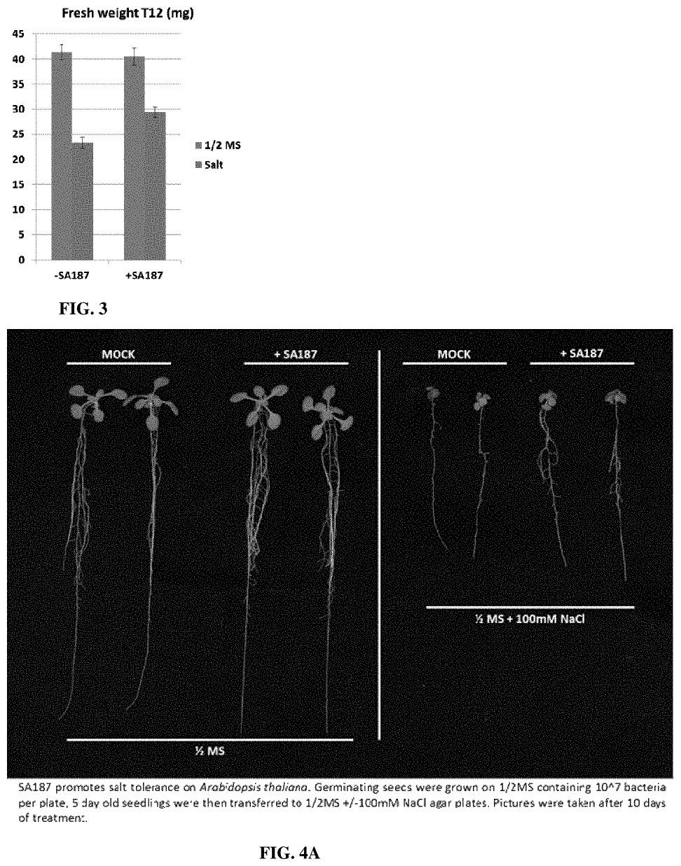

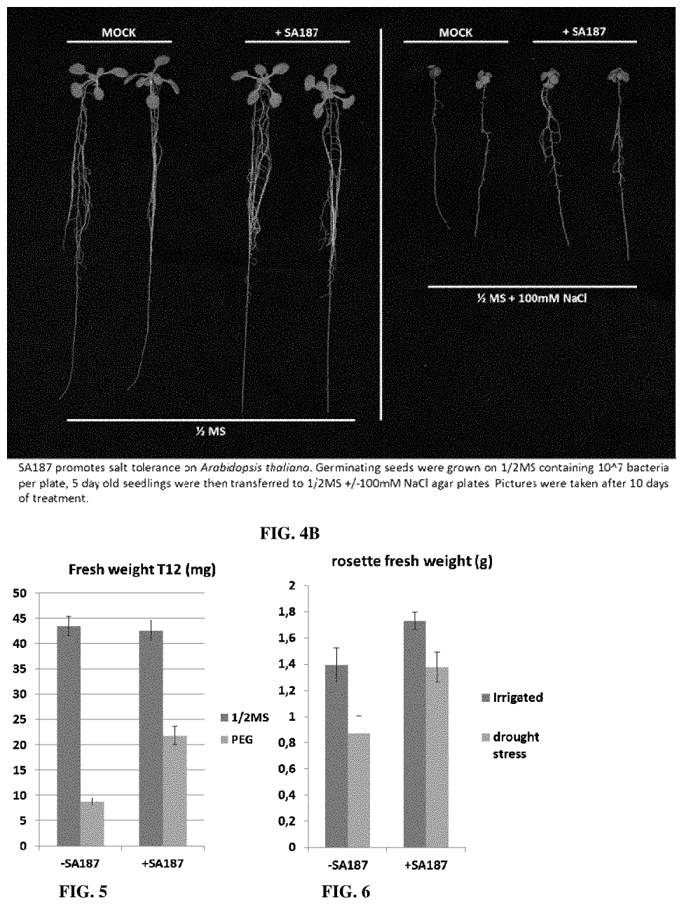

Five-day-old seedlings were transferred on ½ MS plates with or without 100 mM NaCl (Sigma). Primary root length was measured using ImageJ software after scanning the plates. Lateral root density was evaluated as detectable number of lateral roots under a stereo microscope divided by the primary root length (FIGS. 4A-4B). Fresh weight was measured 12 days after transfer of seedlings. Dry weight was measured by drying the different plant organs 2 days at 70° C. To address the ethylene involvement on Arabidopsis adaptation to salt stress, ACC (1-aminocyclopropane-1-carboxylic acid, Sigma), KMBA (2-keto-4-methylbutyric acid, Sigma), AVG (Aminoethoxyvinylglycine, Sigma) and AgN03 (Silver nitrate, Sigma) were added concentrations in ½ MS plates with 100 mM NaCl.

For osmotic shock treatment, stress evaluation was performed by transferring plants on PEG plates (−0.5 MPa) as described previously4. For the heat stress treatment, 6-day-old seedlings plants were given a 37° C. preheat treatment for 1 h, and then subjected to heat stress of 42° C. for 3 h. Plants were then transferred to normal growth conditions (22° C.) for one week. The survival rate was quantified by counting the percentage of the surviving plants.

All plants were grown in long day conditions in growth chambers (Percival; 16 h light/8 h dark, 22° C.) for 10 to 12 more days. Each experiment was performed at least in three biological replicates.

Na+ and Content Determination

Dry rosettes and root systems were weighted. All samples were measured individually except for salt-treated root systems, whereby pools of 3 samples were used for measurements. Sodium and potassium concentrations were measured for shoot and root dry samples by digestion method, using 1 mL of freshly prepared 1% HNO3 (trace metal grade, Fisher Scientific) that was added to the pre-weighed samples. The concentrations of sodium and potassium were determined, using Inductively Coupled Plasma Optical Emission Spectrometer (Varian 720-ES ICP OES, Australia).

Results

Root length, lateral root density were assayed after 8 days (FIG. 2). After 12 days of treatment, plants were weighed (FIG. 3). Overall those results indicate that SA187 can enhance Arabidopsis growth under salt stress conditions by ca. 25% fresh weight and increasing the lateral root density of the stressed plants by 60%. As shown in FIG. 3, this increase will be amplified over time indicating that this beneficial action will increase over time ending with highly improved plant growth when faced by salt stress.

Similar results were obtained using ½ MS+5% PEG (Polyethylene Glycol 6000), a compound known to induce osmotic stress on the plants.

SA187 possess a number of plant growth promoting (PGP) traits, such as the solubilization of Zn, production of siderophores and production of indole acetic acid (IAA). SA187 can tolerate different abiotic stresses including salt stress up to 2M NaCL and osmatic stress-up to 20% poly ethylene glycol 8000: PEG8000) mimicking drought stress in vitro (FIG. 5).

Those results show that SA187 induces tolerance to multiple environmental stresses on Arabidopsis thaliana. It is also important to note that SA187 does not have any detrimental effect on plant growth under optimal conditions.

### Example 4: Drought Tolerance Test on Arabidopsis thaliana

Materials and Methods

The beneficial effect of SA187 was also tested in a greenhouse:

Bacterialized 3 week old Arabidopsis plants were submitted to a 3 week drought treatment and then rewatered again. After one week of rewatering, aerial parts were collected and weighed.

Results

As shown in FIG. 6, SA187 increases Arabidopsis fresh weight by 25% in optimal conditions and almost 60% after water stress confirming the results obtained in vitro. This experiment also points out that SA187 acts beneficially in the long term on the development of Arabidopsis thaliana in normal conditions.

### Example 5: Field Trial on Durum Wheat

Materials and Methods

SA187 was tested during a field trial at the ICBA station in Dubai (United Arab Emirates). These assays aimed to verify if the results obtained in highly controlled conditions could be confirmed in field conditions. Seed lots of durum wheat were inoculated by soaking in a bacterial solution and kept shaking for 4 hours, then allowed to dry on filter paper. Seed sowing was performed on the fields of the ICBA experimental station. Soil samples were collected from the plots irrigated with fresh water for analysis. The average value for the pH was 7.45 and the salinity of the soil was EC=4.9 ds/m (EC>4 ds/m is considered saline). Germination was recorded in all plots without any visible differences between subplots.

Field Trial

Two field stations were chosen to conduct the trail experiments; both fields are located in desert area exposed to high average temperature through the year, low rain, availability of source of ground water, poor loamy sandy soil, with poor organic matter. Unless mentioned later, other agronomic practices were kept uniform across the treatments throughout the experiment in the two field station.

Seeds of durum wheat (Triticum durum) local Karim variety were washed thoroughly in sterile distilled water and then soaked in bacterial suspension solution (2·108 cell rnL−1) for 4 h with shaking, bacterial suspension was removed and the seeds left to air dry over 3 MM filter paper (Whatman) for 6 h. Durum wheat field trail was carried out at the SCADA field station at International Center for Biosaline Agriculture, Dubai, United Arab Emirates (ICBA-UAE), in period of 2014-2016 (N 25° 5′40.9″, E 55° 23′23.6″). The experiment was conducted using a randomized complete block design; each plot is (2.5×2.0 m) with three replicates. Ten-row plots were prepared with intra- and inter row distances of 20 cm and 50 cm, respectively. All the plots were irrigated with ground water with EC=0.3 dS m″1, the average soil pH was 7.45 and soil salinity EC=4.9 dS m″1. The agronomical data were collected on plant height, plant biomass, number of tillers per plant, spike height, number of spikes plant, number of seeds per spike, and total grain yield per plot.

For inoculation of alfalfa which has smaller seeds size, a slurry was prepared consisting of sterilized peat, a broth culture of SA187, and sterilized sugar solution (10%) in the ratio 5:4:1 (w/v/v). Subsequently, alfalfa seeds were coated with the slurry at a rate of 50 mL-kg″1. For the control, seeds were coated with a similar mixture without bacteria. Field trial was conducted at experimental station in Hada Al-Sham, Kingdom of Saudi Arabia, in the period of 2015-2016 (N 21° 47′47.1″ E 39° 43′48.8″). The experiment was a randomized complete block design with a split-split plot arrangement of four replicates, plots (2×1.5 m) with seed spacing 20 cm row-to-row. The field was irrigated using saline ground water with three different salinity level (EC 3.12, 5.46, and 7.81 dS m″1), at the research station, two sources of water were available with a salinity of EC 3.12 and 7.81 dS m″1, and saline water with EC 5.46 dS m″1 was prepared by mixing the two sources. The average soil pH was 7.74 and soil salinity EC=1.95 dS m″1. The agronomical data were recorded every 25-30 days after each cut; this includes plant height and yield as fresh and dry weight.

Results

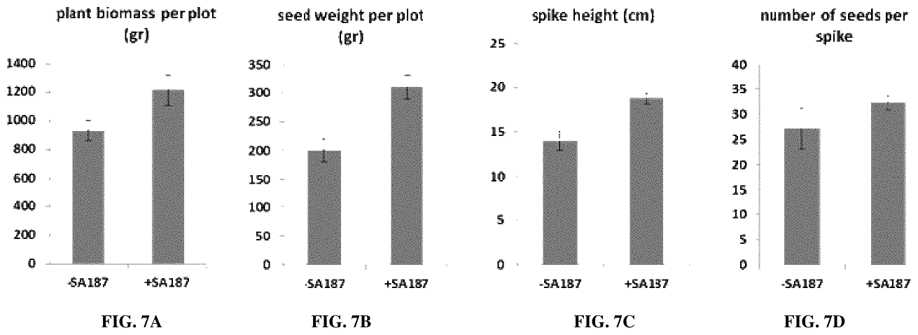

Overall this field experiment proved that SA187 increased crop yield by 50% in the hot and arid conditions of fields in the United Arab Emirates showing increased plant biomass (FIG. 7A)., seed number per spikes (FIG. 7D). and seed weight per plot (FIG. 7B). These results establish that SA187 can be used for agronomical purposes as it can significantly enhance crop yield.

The results show the beneficial impact of SA187 on plant growth and yield. This bacterial strain is performing positively on different plant species and improves their development and yield under environmental stresses in controlled in vitro and greenhouse conditions but also in open field trials showing its wide potential for agronomical application.

### Example 6: Assessment of Stress Tolerance

To test whether SA187 can confer enhanced stress tolerance to plants beyond its natural host, the model crucifer plant Arabidopsis thaliana was tested. SA187 did not negatively influence the germination rate of Arabidopsis seeds, and morphological changes became obvious 5 days after germination: Primary roots were significantly shorter and exhibited longer root hairs compared to non-treated seedlings.

Materials and Methods

SA187 inoculated plants were transferred on medium with or without 100 mM NaCl to monitor PGP or stress-tolerance promoting (STP) capacity.

Results

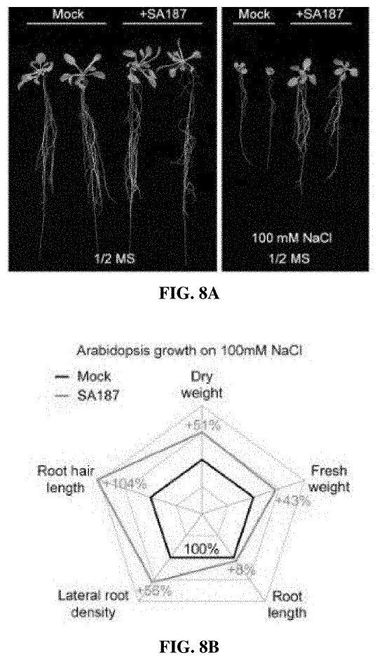

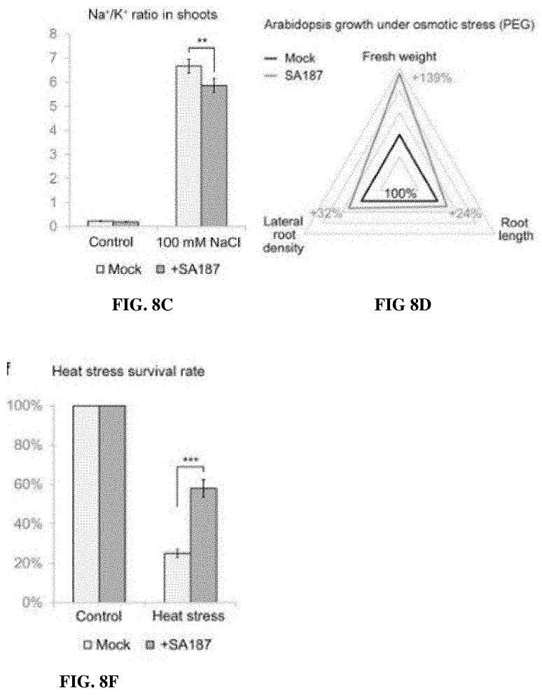

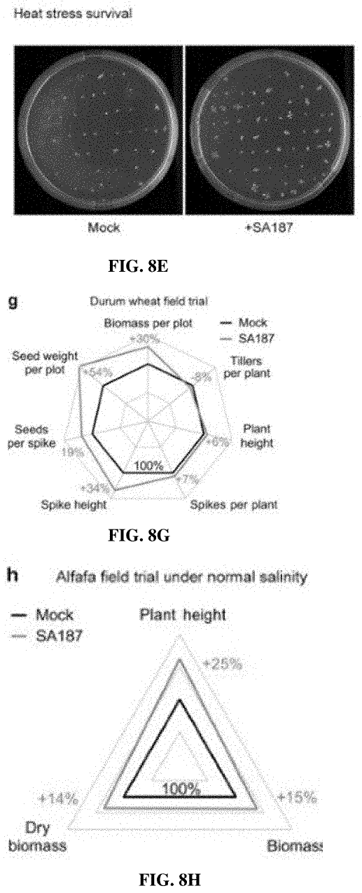

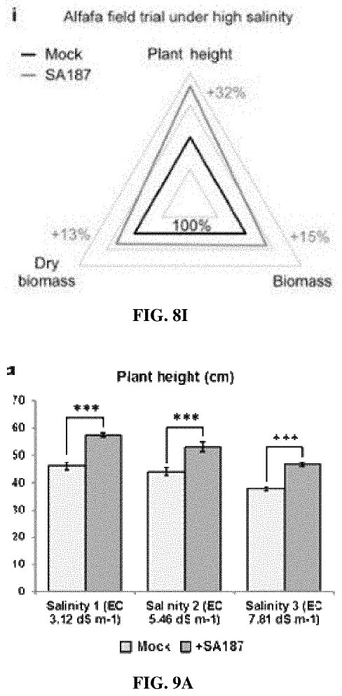

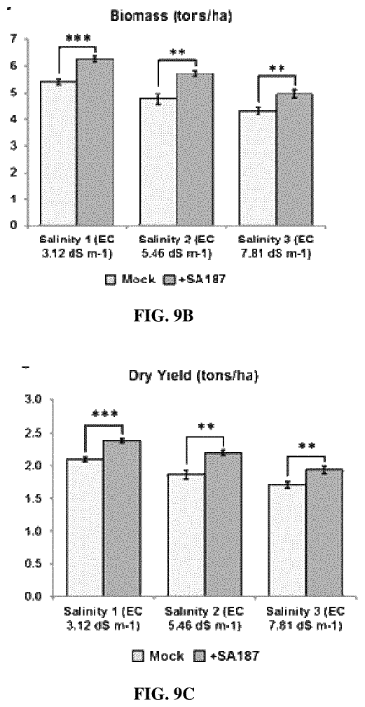

As evaluated by shoot and root fresh and dry weight, root length, lateral root density or ion content, SA187 had a neutral impact on Arabidopsis growth in control conditions, indicating that SA187 is not PGPR per se. However, under salt-stress condition, SA187-treated plants exhibited clear positive effects as shown by an increased fresh weight of roots and shoots (FIG. 8A, 8B, 9A-9C). Principal root growth was similar between control and SA187-inoculated plants under salt stress conditions, but lateral root density was significantly increased (FIG. 8B). The higher salt tolerance of SA187-inoculated plants can be explained by an enhanced K+ content, thereby changing the Na+/K+ ratio under salt stress conditions.

SA187 was also evaluated for its capacity to enhance Arabidopsis tolerance to other abiotic stresses. SA187-inoculated plants exhibited a higher heat stress survival rate (52%) when compared to non-treated plants (22%) (FIG. 8G, 8H). Plant growth was also improved by SA187 when subjecting plants to osmotic stress (FIG. 8). These results indicate that Sa187 confers multi-stress tolerance to Arabidopsis thaliana.

### Example 7: Assessment of Agronomic Use of SA187

Materials and Methods

To evaluate the potential agronomic use of SA187, its beneficial activity was tested under desert field conditions using two agronomically important crops: A durum wheat field trial was performed in poor sandy soil in the hot desert climate of Dubai, United Arab Emirates.

Results

During a typical growing season, SA187 enhanced wheat biomass by 30%, but also spike height, and most importantly grain yield by over 50% (FIG. 8I). Alfalfa was grown on sandy soil fields near Jeddah, in Saudi Arabia.

SA187-treated alfalfa exhibited an increase of around 20% for plant height and biomass, independently of irrigation, with regular or high salty water (FIG. 8E).

### Example 8: Assessment of Plant Interaction with SA187

Materials and Methods

To characterize the interaction of SA187 with plants in more detail, its capacity to colonize Arabidopsis seedlings was analyzed on ½ MS agar or turf-based soil.

Generation of GFP-Labelled Bacteria

SA187 was genetically labeled with the GFP expressing cassette by taking advantage of the mini-Tn7 transposon system⁵. In order to specifically select for the bacterium carrying the GFP integration in the genome, a spontaneous rifampicin resistant version of the strain was obtained first⁶: an overnight-grown culture of SA187 was plated on LB plates amended with 100 μg·ml⁻¹ of rifampicin and the plates were incubated for 24 h at 30° C. At least 10 colonies, representing spontaneous rifampicin resistant mutants of the strain were streaked twice on LB plates containing 100 μg·ml⁻¹ of rifampicin and thereafter twice on LB plates supplemented with 200 μg·ml⁻¹ of rifampicin. The rif^{R} SA187 strain was then used for the transformation assay by conjugation as described previously.

Results

SA187, which was stably transformed to express green fluorescent protein (GFP) while having the same effect on plant as the wild type strain colonized both roots and shoots (data not shown). On roots, colonies established themselves preferentially in grooves between epidermal cell files, before forming large colonies proportionally to the age of the root region. On vertical agar plates, SA187-GFP colonies were found inside root tissues in 22% of cases around the base of lateral roots (data not shown). Occasionally, SA187 was detected in the root apoplast of soil-grown seedlings far from lateral roots (data not shown). Bacterial colonies were also found deep inside the apoplast of hypocotyls, cotyledons and leaves, and in several cases bacterial cells were observed to penetrate through stomata of these organs (data not shown).

### Example 9: Assessment of Signaling Pathways Affected by SA187

Materials and Methods

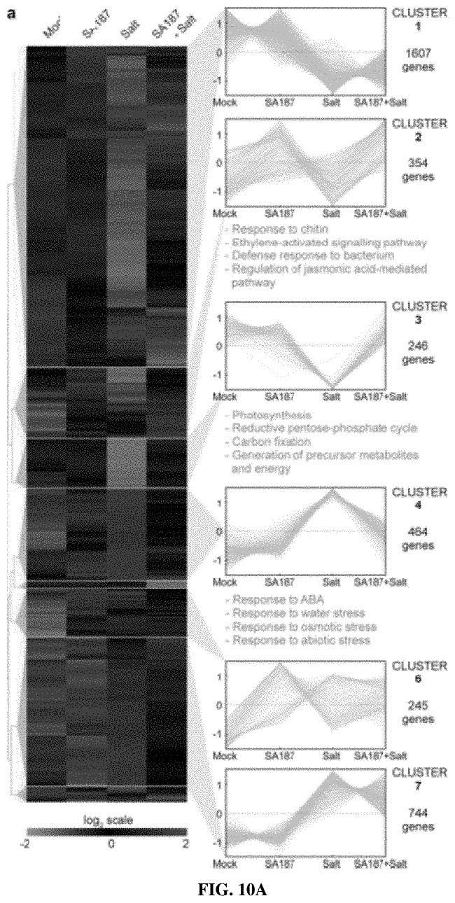

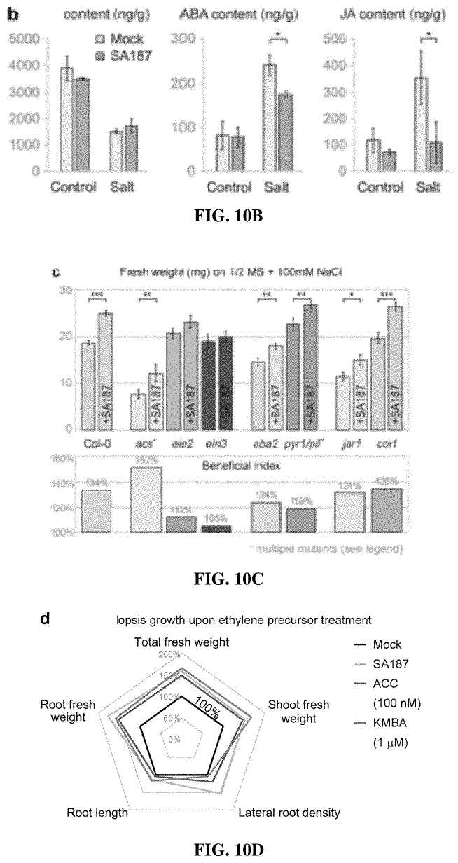

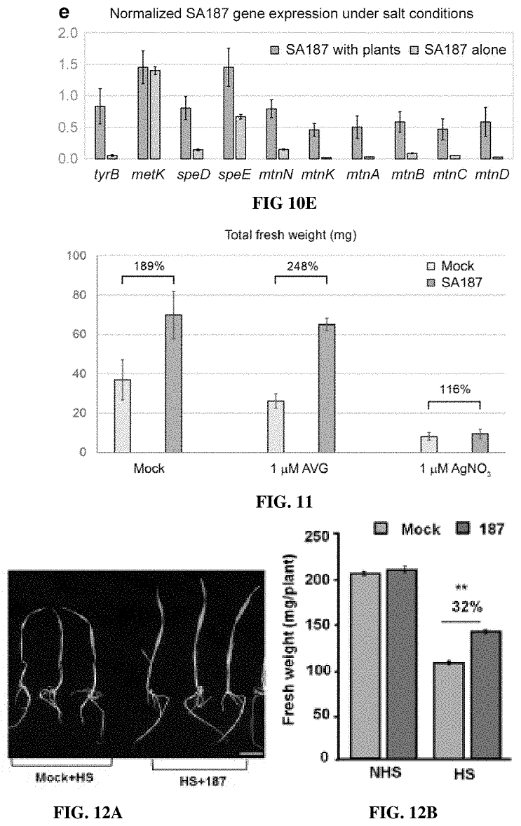

To identify which signaling pathways are affected in plants upon SA187-colonization under normal and salt stress conditions, RNA-seq analyses were conducted, comparing 4 conditions: Mock treated plants (Mock), SA187-inoculated plants (SA187), salt treated (Salt) and SA187-inoculated plant under salt stress (SA187+Salt). The transcriptome data were analyzed by hierarchical clustering into 8 groups (FIG. 10A).

Results

The major differences between SA187- and non-inoculated plants were observed in clusters 2, 3 and 4. Cluster 3 corresponds to genes with a role in primary metabolism, such as photosynthesis and energy metabolism, that are downregulated under salt stress conditions in non-inoculated plants, whereas cluster 4 genes are involved in ABA and abiotic stress, that are found to be upregulated in salt treated plants, but not when they are treated with SA187. These results indicate that under salt stress conditions, SA187 might maintain a high metabolic rate and not activate all of the abiotic stress response pathways. Cluster 2 represents defense related genes and in particular those for ethylene, jasmonic acid and chitin signaling. Interestingly, this cluster of genes is already upregulated when plants are inoculated by SA187 under non-salt conditions.

Since the transcriptome analysis indicated possible roles of the hormone pathways involved in abiotic and biotic stress, SA, JA and ABA Levels were measured in control and colonized Arabidopsis plants. SA quantification showed that SA187 did not significantly change salicylate in the absence or presence of salt (FIG. 10B). ABA and JA levels in the absence of salt stress remained unchanged upon SA187 colonization, but their accumulation was significantly lower in SA187-colonized plants under salt stress (FIG. 10B). These data largely confirmed the transcriptome data and show that JA and to a lesser extent ABA levels are modulated by SA187 in salt stressed plants.

### Example 10: Phytohormone Quantification

Materials and Methods

To complement the phytohormone quantification, hormone-deficient or insensitive mutants were analyzed. The beneficial activity of SA187 was evaluated on the JA-receptor coil-1 mutant15 and JA-insensitive jar 116, the ABA biosynthesis aba2 mutant17 or the ABA receptor quadruple pyrlpillpil2pil4 mutant {quad pyr).

Hormone Content Analysis

For each sample, 10 mg of freeze-dried powder were extracted with 0.8 mL of acetone/water/acetic acid (80/19/1 v:v:v). For each sample, 2 ng of each standard was added to the sample: ABA, salicylic acid, jasmonic acid, and indole-3-acetic acid stable labelled isotopes used as internal standards were prepared as described previouslyl2. The extract was vigorously shaken for 1 min, sonicated for 1 min at 25 Hz, shaken for 10 minutes at 4° C. in a

Thermomixer (Eppendorf), and then centrifuged (8000 g, 4° C., 10 min). The supernatants were collected, and the pellets were re-extracted twice with 0.4 mL of the same extraction solution, then vigorously shaken (1 min) and sonicated (1 min; 25 Hz). After the centrifugations, three supernatants were pooled and dried.

Each dry extract was dissolved in 140 μL of acetonitrile/water (50/50; v/v), filtered, and analyzed using a Waters Acquity ultra performance liquid chromatograph coupled to a Waters Xevo Triple quadrupole mass spectrometer TQS (UPLC-ESI-MS/MS). The compounds were separated on a reverse-phase column (Uptisphere C18 UP3HDO, 100×2.1 mm, 3 μm particle size; Interchim, France) using a flow rate of 0.4 mL·min⁻¹ and a binary gradient: (A) acetic acid 0.1% in water (v/v) and (B) acetonitrile with 0.1% acetic acid. For ABA, salicylic acid, jasmonic acid, the following binary gradients were used (time, % A):(0 min, 98%), (3 min, 70%), (7.5 min, 50%), (8.5 min, 5%), (9.6 min, 0%), (13.2 min, 98%), (15.7 min, 98%), and the column temperature was 40° C. Mass spectrometry was conducted in electrospray and Multiple Reaction Monitoring scanning mode (MRM mode), in the negative ion mode. Relevant instrumental parameters were set as follows: capillary 1.5 kV (negative mode), source block and desolvation gas temperatures 130° C. and 500° C., respectively. Nitrogen was used to assist the cone and desolvation (150 L·h⁻¹ and 800 L·h⁻¹, respectively), argon was used as the collision gas at a flow of 0.18 mL·min⁻¹. Samples were reconstituted in 140 μL of 50/50 acetonitrile/H₂O (v/v) per mL of injected volume. The limit of detection (LOD) and limit of quantification (LOQ) were extrapolated for each hormone from calibration curves and samples using Quantify module of MassLynx software, version 4.1.

Results

In all cases, SA187 beneficial activity was maintained upon salt stress in these hormone-related mutants (FIG. 10C). However, the ethylene insensitive ein219 and ein3 mutants20 were strongly compromised in the beneficial effect of SA187, indicating that ethylene signaling is a major factor in this process.

This result was validated by qPCR analysis of a number of ethylene-induced genes upon colonization by SA187 and by demonstrating the strong activation of the ethylene-dependent reporter EBF2::GUS in response to SA187 (data not shown). Moreover, application of the ethylene precursor ACC (100 nM) during salt stress could largely mimic the beneficial activity of SA187 on plants (FIG. 10D).

Surprisingly, the heptuple ethylene biosynthesis deficient mutant acsl-Iacs2-1acs4-1acs5-2acs6-1acs7-1acs9-1 (kept acs)21 still showed full sensitivity to the beneficial activity of SA187 (FIG. 10C). Moreover, SA187-beneficial effect is still existing while using the ethylene production inhibitor Aminoethoxyvinylglycine (AVG), however when they were treated with Silver nitrate (AgNC\hat{ }), an interferer of ethylene perception, SA187 lost its activity towards Arabidopsis (FIG. 11). This would suggest that ethylene production might not originate from plants but be derived from SA187 itself. To elucidate this question, a search was conducted for ethylene forming enzyme (EFE), or ACC Synthase genes in the genome of SA187, but no related genes were found. The bioinformatic analysis was confirmed by showing that SA187 does not produce ethylene when grown on synthetic media, However, some bacteria can indirectly produce ethylene via the production of KMBA, an intermediate of the methionine salvage pathway23′24. KMBA can spontaneously convert to ethylene by photo-oxidation or by peroxidases25, which are rich in the plant apoplastic compartment. Interestingly, the KMBA pathway is completely conserved in SA187 and gene expression levels of most of the KMBA pathway enzymes were shown to be highly upregulated upon plant colonization compared with bacteria grown on synthetic medium (FIG. 10E).

To confirm that KMBA could function as an ethylene precursor during the beneficial plant-microbe interaction, different concentrations of KMBA were tested on Arabidopsis in the absence of SA187. As shown in FIG. 10D, a 100 nM KMBA concentration showed similar beneficial activity on salt stress tolerance on Arabidopsis plants as SA187 or ACC (FIG. 10D).

In summary, the endophytic bacteria Enterobacter sp. SA187 promotes plant tolerance to abiotic stresses. The capacity of SA187 to colonize both outer and inner tissues of Arabidopsis roots and shoots supports a functional interaction, using natural openings for internalization. Interestingly, based on transcriptomic and genetic evidence, it was demonstrated that SA187 beneficial activity is mediated by indirect production of ethylene through the production of KMBA, a pathway only activated when bacteria interact with plants. Although microbial PGPR activity is commonly attributed to a reduction of the plant ethylene contents through the activity of bacterial ACC deaminases26-29, or independent of the ethylene signaling pathway30′31, the role of ethylene in plant abiotic stress tolerance is not clear. Up to now, only few reports hypothesized the involvement and activation of the ethylene signaling pathway to explain abiotic stress tolerance induction of rhizospheric bacteria and are largely based on volatile emission or by comparison with plant-fungal interactions ‘˜. These results strongly agree with those of Peng et al. (2014), where pretreatment with external ethylene or an EIN3/EIL1 gain-of-function mutant were sufficient to enhance salt stress tolerance36. Finally, an important outcome of this work is to show that SA187 can also promote biomass and yield increases on taxonomically unrelated plant crop species. These results show that the use of bacterial strains such as SA187 could provide an eco-friendly non-GMO solution for increasing agricultural production of many crops in a sustainable way.

### Example 11. A Novel Mechanism of Root Endophyte-Induced Thermotolerance, Opening the Way to Use Beneficial Microbes to Adapt Agriculture to the Challenges of Global Warming

Materials and Methods

Bacterial Inoculum and Media Preparation

Enterobacter sp. SA187 was isolated from root nodules of Indigofera argentea in the Jizan region of Saudi Arabia (Andres-Barrao et al, 2017). Cryogenically maintained Enterobacter sp. SA187 were streaked out on LB agar media and incubated at 28° C. for 24 h. A single colony was used for further experiments. For bacterial seed plates, 50 ml of half-Murashige and Skoog medium (MS) with 0.9% agar and a pH of 5.8 was mixed with 0.1 ml of fresh bacterial suspension with an OD of 0.2 to obtain a final number of 10⁵ CFU/ml. For control plates, 0.1 ml of liquid LB was mixed with ½ MS media.

Field Experiments

Experiments were carried out at the SCADA field station of the International Center for Biosaline Agriculture (ICBA), Dubai, UAE (25° 05042.0″N 55° 23023.3″E), during three growing seasons 2014/15, 2016/17, and 2017/18. ICBA field area has Hyperthermic TypicTorripsamment soil type which characterized with very low nutrient contents (Shahid et al, 2009). Soil physical and chemical properties (Table 2) were determined according to Alzubaidy et al (2016).

TABLE 2
Average soil properties and elemental composition of the different
experimental plots (0-30 cm) on ICBA used for Wheat experiment, the data
presented are mean values (± standard error)

| Soil properties | Values ± SE |
|---|---|
| pH | 7.45 ± 0.06 |
| Organic matter (%) | 1.46 ± 0.05 |
| EC (dS in−1) | 1.9 ± 0.09 |
| Soil color and texture | Brown Sandy |
| Total N (%) | 0.16 ± 0.08 |
| Elements | Quantity (mg kg−1) |
| P | 37.09 ± 1.6 |
| K | 261.92 ± 9.2 |
| Ca | 2455.04 ± 104.9 |
| Mg | 140.88 ± 10.04 |
| S | 168.19 ± 8.6 |
| Na | 241.62 ± 8.77 |
| B | 6.62 ± 0.42 |
| Mn | 7.52 ± 0.95 |
| Fe | 37.22 ± 2.41 |
| Co | 3.12 ± 0.52 |
| Cu | 1.32 ± 0.05 |
| Zn | 1.39 ± 0.08 |

The compost (manure) was applied with the rate of 40 tons per hectare (t/ha) in the area selected for experiment 15 days before sowing. Seeds of Karim (Triticum durum) cultivar were coated with a mixture containing broth culture, sugar solution (10%) with a rate of 2×10⁹ cell/kg seed. The inoculated seeds were kept for 1 h, and thereafter, the seeds were air-dried over 3 MM filter paper (Whatman) and sown immediately. Control (mock-inoculated) seeds were coated with a mixture containing all components without SA187. The wheat seeds were sown manually during the first week of November from each growing seasons and harvest by end of April beginning of May. Meteorology data including temperature and rainfall were recorded. The experiment was conducted using a randomized complete block design; each plot is 5 m² with three replications. All the plots were irrigated with water EC=0.3 dS/m, the average value for the soil pH was 7.45, and the salinity of soil was EC=1.9 dS/m. Agronomical data were collected upon wheat harvest, including plant height, biomass, tiller number, height, number and seeds per spike, 1,000 seed weight, total grain yield, and total biomass yield.

DNA Extraction, 16S rRNA Gene Amplicon Sequencing, and Data Processing

Total DNA extraction of endophytic bacterial community was performed as described by (Eida et al, 2018). Total DNA was extracted from 300 mg of soil or plant root material (duplicates) using the PowerSoil DNA Isolation Kit (MO BIO Laboratories). Sequencing libraries of bacterial communities of soil, rhizosphere, and root endosphere were prepared according to the Illumina 16S Metagenomic Sequencing Library Preparation guide with using the V5-V7 region (Beckers et al, 2016). The V5-V7 region was amplified using a two-step PCR protocol with V5-V7 primers (799F: 5′-TCGTCGGCAGCGTCAGATGTGTATAAGAGACAG ACMGGATTAGATACCCKG-3′ (SEQ ID NO:1); 1193R: 5′-GTCTCGTGGGCTCGGAGATGTGTAT AAGAGACAG ACGTCATCCCCACCTTCC-3′ (SEQ ID NO:12), overhang adapter sequences are underlined) for the first PCR step and Illumina Nextera XT Index kit (Illumina Inc., San Diego, Calif., USA) for the second PCR step. The first PCR step (amplicon PCR) was performed using the above primer set with NEBNext® Q5® Hot Start HiFi PCR Master Mix (New England Biolabs) in a total volume of 5011. The cycle conditions were as follows: initial cycle at 98° C. for 1.5 min, 30 cycles of denaturation at 95° C. for 30 s, annealing at 53° C. for 30 s, and 65° C. for 45 s with a final extension 65° C. for 5 min. The duplicate PCR amplicons were then pooled and run on 2% agarose gel (140 V for 45 min, 25-30 W) in order to clear the samples from residual primers, primer dimers, and mitochondrial/chloroplast DNA. The lower bands corresponding to bacterial amplicons (˜500-550 bp) were excised from the gels and purified using the Wizard_{┐} SV Gel and PCR Clean-Up System (Promega). Subsequently, 5 ng of purified PCR product was used for a second round of PCR amplification using Illumina Nextera XT Indexes and same cycle conditions as first step PCR for eight cycles instead of 30 cycles. Amplicons were cleaned using Agencourt AMPure XP (Beckman Coulter Inc., Brea, Calif., USA) magnetic beads. Libraries were validated with Qubit dsDNA HS assay kit (Thermo Fisher Scientific) and Agilent 2100 bioanalyzer with the DNA 7500 kit (Agilent Technologies) and quantified with qPCR using KAPA library quantification kit (KAPA Biosystems). The library was normalized and sequenced at the KAUST Bioscience Core Labs on an Illumina MiSeq (Illumina Inc.) with 2×300 bp paired-end reads and V3 chemistry. MiSeq sequencing of the V5-V7 region of the 16S rRNA gene yielded 1,396,927 sequences with a mean length of 301 bp. Microbiome data were analyzed according to Eida et al (2018) using the software MOTHUR (version 1.42.3) (Schloss et al, 2009). After quality filtering, and exclusion of chimeras amplified, sequences were annotated to bacteria. Sequences were classified against Greengenes database using bootstrapping of 60 (McDonald et al, 2012). For further analysis, sequences were clustered into operational taxonomic units (OTUs) using a 97% similarity cut-off. Alpha diversity index, beta diversity, and principal coordinate analysis (PCoA) were performed as implemented in mother (Schloss et al, 2009).

Plant Material and Growth Conditions for Wheat and Arabidopsis thaliana

Arabidopsis thaliana Col-0 seeds were obtained from publicly available collections. hsfa1-q and hsfa2 seeds were obtained from Yeeyung Charng (ABRC, Taipei, Taiwan). The HSFA2 complemented lines (pHSFA2::HSFA2-GFP) were generated by agrobacterium mediated floral dip of hsfa2 mutant. The genomic locus of HSFA2 containing the promoter and gene body was cloned into pMDC107 vector generating a c-terminal GFP tag. Seeds were surface-sterilized for 15 min for wheat and 10 min for A. thaliana with 0.05% SDS solution prepared in 70% ethanol, followed by three times washing with absolute ethanol. The sterilized seeds were plated on ½ MS medium agar plates seeded with 105 CFU/ml SA187. Seeds were stratified at 4° C. for 2 days and then plates were transferred to a growth chambers (Model CU36-L5, Percival Scientific, Perry, Iowa, USA) under a 16-h photoperiod and 8-h dark conditions at 22° C. for germination and seedling growth.

Heat Priming and Heat-Shock Experiment

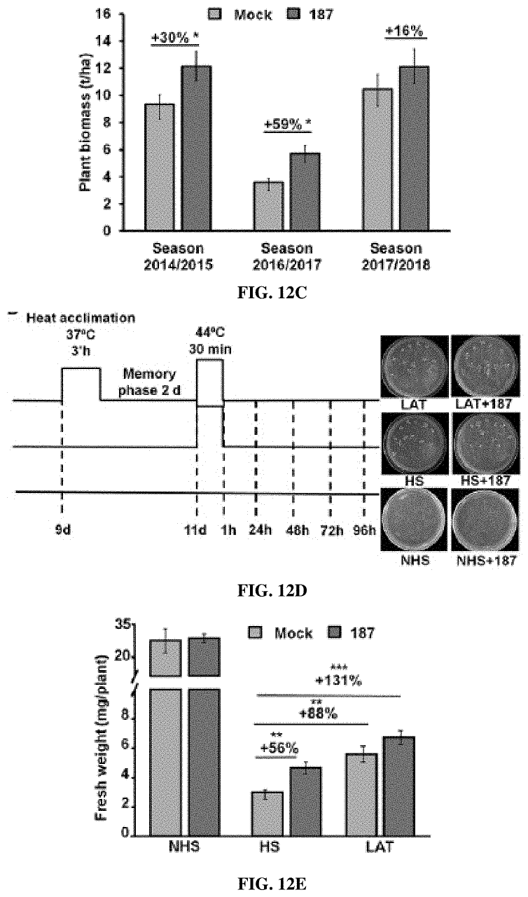

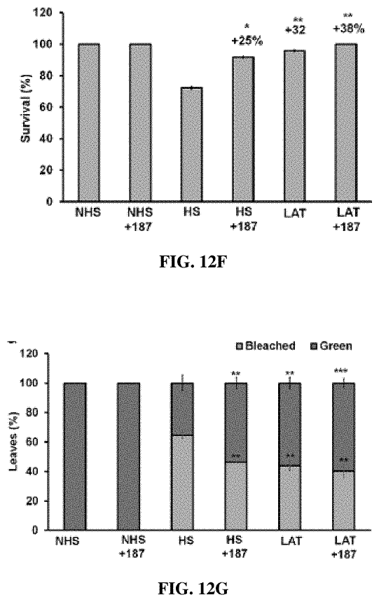

A heat-priming platform was developed by modifying a previous method (Larkindale & Vierling, 2008). For A. thaliana, 5-day-old SA187-inoculated and non-inoculated seedlings of near equal lengths were transferred to new ½ MS plates, while for wheat, 2-day-old seedlings were transferred on 50-ml falcon tubes. For HS treatments in Arabidopsis, plants with bacteria and without bacteria were divided into three sets of plates. In set 1, plants were given acclimation HS treatment, where 9-day-old SA187-colonized and non-colonized plants were exposed to 37° C. of heat acclimation for 3 h followed by 2 days recovery at 22° C. and a further 44° C. HS for 30 min at day 11 (LAT). In set 2, SA187-inoculated and non-inoculated plants were exposed directly to 44° C. HS from 30 min on day 11 (HS). For the 44° C. treatment, a preheated water bath was used. In set 3, SA187-inoculated and non-inoculated plants were grown under normal conditions at 22° C. (NHS). The same HS procedure was performed for all experiments and the arrows indicate the sampling points for the respective collection and data analysis of the plants (FIG. 12D). For wheat experiment under laboratory conditions, 6-day-old colonized, and non-colonized plants were exposed to 44° C. for 2 h and fresh weight was measured for 9-day-old plants.

Quantification of SA187-Colonization

Seedlings were germinated on ½ MS agar plates inoculated with SA187, and 5-day-old seedlings were transferred to new ½ MS plates (12 seedlings per plate). At day 11, plants were heat-stressed 44° C. HS from 30 min, and samples were taken at 0 h as control, 1, 24, and 48 h after 44° C. HS for CFU analysis. Plants were ground in Eppendorf tubes using homogenizer. Further, sample was resuspended in 1 ml of extraction buffer containing 10 mM MgCl2, 0.01% Silwet L-77, vortexed for 10 min. Serial dilutions were performed and samples were plated on LB agar plates, and colony forming units (CFUs) were counted after overnight incubation at 28° C. Calculated number of CFUs was normalized per mg of plant material. The experiment was conducted in three biological replicates, each with two technical replicates per condition.

RNA Extraction, Reverse Transcription, and qRT-PCR

For RNA-seq analysis, total plant RNA was extracted from non-heat stressed (NHS), NHS+187, heat stress (HS), HS+187, long-term acquired thermotolerance (LAT), and LAT+187 treatments after 96 h of HS treatment (from 15-day-old seedlings), while for targeted gene expression studies, plant samples were harvested from NHS, NHS+187, HS, HS HS+187, LAT, and LAT+187 samples after 1, 24, 48, 72, and 96 h of HS treatment using the Nucleospin RNA plant kit (Macherey-Nagel), including DNasel treatment, according to the following manufacturer's recommendations. For qPCR analysis, the total RNA was reverse-transcribed using a using Superscript III (Invitrogen): 1 lg of total RNA and oligo-dT as primer. For Arabidopsis gene expression analyses, tubulin was used as a reference gene. All reactions were done in a CFX96 Touch Real-Time PCR Detection System (Bio-Rad) as follows: 50° C. for 2 min, 95° C. for 10 min; 40× (95° C. for 10 s and 60° C. for 40 s). All reactions were performed in three biological replicates, and each reaction as a technical triplicate. Accession numbers of the genes studied were HSFA2 (At2g26150), HSP101 (At1g74310), HSP70 (At3g12580), HSP70b (At1g16030), GA3OX1 (At1g15550), XTR6 (At4g25810), MIPS2 (At2g22240), HSP90 (At5g52640), ATERDJ3A (At3g08970), HSP18.2 (At5g59720), APX2 (At3g09640), and TUB6 (At5g12250). A list of all primers used in the current study is provided in Table 4.

| | |
|---|---|
| Gene Name | Primer |

qRT-PCR primers used for Heat responsive genes

| | |
|---|---|
| MIPS2 -F | GTAGCTAGTAATGGCATCCTCTTTGA |
| | (SEQ ID NO: 3) |
| MIPS2-R | ATCCGCAACATATGGCACATAC |
| | (SEQ ID NO: 4) |
| XTR6-F | TGTCACCGCTTACTATTTGAAATCC |
| | (SEQ ID NO: 5) |
| XTR6-R | GTTTGAATTGTTGTTCTCTATCGCC |
| | (SEQ ID NO: 6) |
| HSP101 F | GTGTTCGACCCCCTTTCACA |
| | (SEQ ID NO: 7) |
| HSP101 R | CGATTTCCTCACGCACAACC |
| | (SEQ ID NO: 8) |
| Hsp70b F | GCAGTGTGCACGATGTTGTT |
| | (SEQ ID NO: 9) |
| Hsp70b R | GCTGTCTCAAGTCCAAGGCT |
| | (SEQ ID NO: 10) |
| HSP70 F | TAAGCTTGACGCAGCTGACA |
| | (SEQ ID NO: 11) |
| HSP70 R | GCCCAGCTCCTTGGTACATT |
| | (SEQ ID NO: 12) |
| HSP90 F | TGGTGGATGCGATTGACGAA |
| | (SEQ ID NO: 13) |
| HSP90 R | TCTCAACCTTGTCCCCGAGA |
| | (SEQ ID NO: 27) |
| GA30X1 F | GATCTCCTCTTCTCCGCTGC |
| | (SEQ ID |
| | NO: 14) |
| GA30X1 R | TTTGGAAGGCACCCCAAGTT |
| | (SEQ ID NO: 15) |
| ATERDJ3A F | CGTTGTGGACCAAGGGATGA |
| | (SEQ ID NO: 16) |
| ATERDJ3A R | GCCCTACGAGGAACTATGCC |
| | (SEQ ID NO: 17) |
| TUB6F | GTCATCTGCAGTTGCGTCTT |
| | (SEQ ID NO: 18) |
| TUB6R | GGTGAAGGAATGGACGAGAT |
| | (SEQ ID NO: 19) |

qRT-PCR primers used for Heat memory genes

| | |
|---|---|
| HSFA2 F | TTGGATGTGGGGAGGAAACG |
| | (SEQ ID NO: 20) |
| HSFA2R | GATTGCTGCAGCGAACAACA |
| | (SEQ ID NO: 21) |
| HSP18.2 F | AACGATAAGTGGCACCGTGT |
| | (SEQ ID NO: 22) |
| HSP18.2 R | TTGAGGCTTCTTCTCAGGCG |
| | (SEQ ID NO: 23) |
| APX2F | ACTCCTTGTCAGCAAACCCGAG |
| | (SEQ ID NO: 24) |
| APX2R | CTTGATGATCCTCTCTTTCTCCCA |
| | SEQ ID NO: 25) |

Primers for Chip-PCR

| | |
|---|---|
| HSP18.2 F1 | GCCCCTAGGGATTTCGACTA |
| | (SEQ ID NO: 26) |
| HSP18.2 R1 | CCCGTAAATAAAGCGGTCAA |
| | (SEQ ID NO: 27) |
| HSP18.2F2 | AATCAGCAGGAAAATCAAGAAC |
| | (SEQ ID NO: 28) |
| HSP18.2 R2 | TCCCATAAGTCTTGCGAGAAC |
| | (SEQ ID NO: 29) |
| APX2 F1 | GGATATCAAACCCAACTTGAAGAGAG |
| | (SEQ ID NO: 30) |
| APX2 R1 | ATAATCTGAGCAAAAGATAAAACACGG |
| | (SEQ ID NO: 31 |
| APX2 F2 | TCGATAGGTTCTCCATTCTCTTTAGG |
| | (SEQ ID NO: 32) |
| APX2 R2 | TTCCTCTTGCATCTCTGAACAGC |
| | (SEQ ID NO: 33) |
| APX2 F3 | CTGTTCCCTATTCTGTCATATGCTG |
| | (SEQ ID NO: 34) |
| APX2 R3 | ACCCTTGATTCTATGGTTCTACCTC |
| | (SEQ ID NO: 35) |

Bioinformatics Analysis of RNA-Seq Data

mRNA libraries were performed with 1 μg of total plant RNA using a stranded mRNA Library Prep kit (Illumina). Pooled libraries were sequenced using Illumina HiSeq 4000 platform which resulted in paired-end reads of length 151 bps. Sequenced reads were checked for quality using FASTQC (Andrews, 2012). Adapter sequences and low-quality reads or base pairs were trimmed using Trimmomatic V0.36 (Bolger et al, 2014). The parameters for read quality filtering were set as follows: minimum length of 36 bp; Mean Phred quality score greater than 30; Leading and trailing bases removal with base quality below 3; sliding window of 4:15. Trimmed reads were then aligned to the TAIR10 and SA187 genome combined using TopHat v2.1.1 (Trapnell et al, 2009; Trapnell et al, 2012; Kim et al, 2013). Reads per million bases and differential expression between two conditions were calculated using Cufflinks v2.2.0 (Trapnell et al, 2009). To identify differentially expressed genes, specific parameters (P-value≤0.05; statistical correction: Benjamini-Hochberg; FDR≤0.05) in cuffdiff were used. Post-processing and visualization of differential expression were done using cummeRbund v2.0.0. A cut-off of 2-fold change and P-value less than 0.05 were set to identify the up- and down-regulated genes between two conditions. Venny (Oliveros, 2007-2015) was used to identify the genes common or unique to different conditions compared. AgriGO (Tian et al, 2017) was used to find the corresponding GO terms (FDR≤0.05) and the functions of the respective genes.

Chromatin Immunoprecipitation

ChIP was conducted as described in previous studies (Lamke et al, 2016a). In short, roughly 500 mg of 10- and 12-day-old seedlings were cross-linked by vacuum-infiltrating 1% formaldehyde for 15 min. Formaldehyde was quenched using 2 M glycine. Samples were stored at −80° C. until further processing. Further, nuclei extraction was performed, and chromatin was sonicated using a Diagenode Bioruptor (medium setting, 14 cycles each with 30 s on/30 s off with ice cooling), yielding fragments with a size of around 250 bp. Antibodies (anti-H3, ab1791; anti-H3K4me3, from Abcam, ab8580 http://www.abcam.com) were pre-coupled to protein A coated agarose beads (Invitrogen) for at least 2 h at 4° C. Immunoprecipitations were done in IP buffer at 4° C. for overnight. After, washing and reverse crosslinking, resulted DNA was extracted using the phenol-chloroform method and precipitated with ice chilled ethanol and glycogen (Invitrogen), and then re-suspended in 20 μl of water. ChIP-PCR was performed for three regions of APX2 and two regions of HSP18.2 gene loci. Amplification values were normalized to H3 (normalized signal modification/normalized signal H3). The given values in graphs are the means of three biological replicates, with each replicate was normalized to the respective 22° C. control with no HS (NHS) sample before averaging.

Results

SA187 Induces Thermotolerance in Wheat

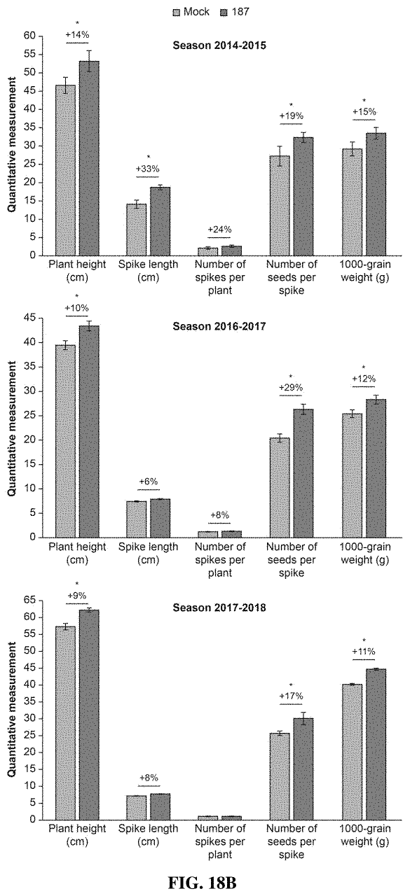

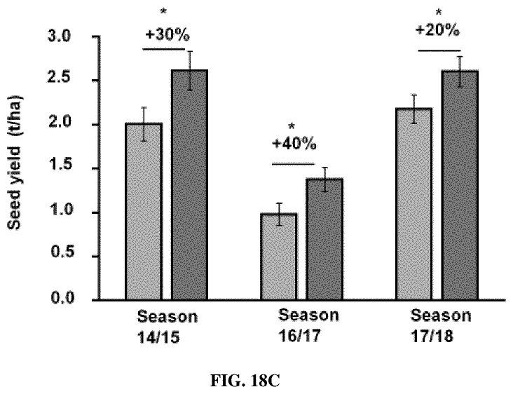

In order to assess the effect of SA187 on the growth of wheat under laboratory conditions, wheat plants were colonized with SA187 and exposed 6-day-old plants to 44° C. HS for 2 h. In contrast to non-colonized plants which showed chlorotic leaf damage and stopped growth upon HS (FIG. 12A), SA187-colonized wheat was protected against HS chlorotic leaf damage (FIG. 12A) and continued growth (FIG. 12B). To test the effect of SA187 on wheat grown under natural desert field conditions of high temperatures, wheat was grown during three growing seasons (2014-2018) at the ICBA field station (Dubai, UAE) characterized by low rainfall and high temperatures of up to42° C. during a typical winter vegetation period (FIG. 18A). When mature plants were assessed for agronomic traits, SA187-treatedwheat showed a 10-14% increase in plant height, 22% more seeds/spike, and a 12% increase in the 1,000 seeds weight (FIG. 18B), Importantly, a consistent increase of 30%, 40%, and 20% in grain yield for SA187-treated plants was observed in the three seasons, giving 2.6 t/ha of seeds (FIG. 18C). Similarly, consistent increases in plant biomass of SA187-treated wheat were observed in the three growing seasons (FIG. 12C).

SA187 Induces Thermotolerance in Arabidopsis thaliana

To investigate the molecular mechanism of SA187-induced plant thermotolerance, studies examined whether SA187 can enhance long-term acquired thermotolerance (LAT) in Arabidopsis. Fresh weight, % survival, and % bleaching and green leaves were evaluated by comparing heat-stressed (HS) to thermoprimed/heat-acclimated (LAT) plants following an acute HS of 44° C. (HS) with and without SA187(±187). For LAT treatment, 9-day-old plants that were grown at 22° C. were treated at 37° C. for 3 h. After 2 days of recovery at 22° C., a 44° C. HS was applied. After a further incubation of 4 days at 22° C., 15-day-old plants were analyzed for phenotypes and transcriptomes. For HS treatment, 11-day-old plants that were grown at 22° C. were directly exposed to 44° C. before further incubation for 4 days at 22° C. Non-heat-stressed (NHS) plants were grown at 22° C. for 15 days in parallel as control (FIG. 12D).

Compared to NHS plants, HS resulted in a major reduction of plant fresh weight, survival, and number of green leaves, while Lat significantly protected plants from HS (FIG. 12D-G). ComparingSA187-colonized (HS+187) to non-colonized plants (HS), HS+187exhibited 57% higher fresh weight, 26% better survival, and 34% more green leaves (FIG. 12E-G). This effect is HS-specific, as under control conditions of 22° C., SA187-colonized (NHS+187) and non-colonized plants (NHS) displayed comparable growth, fresh weight, and survival levels (FIG. 12E-G). These data show that SA187 protects Arabidopsis from HS to a similar degree as thermopriming.

Differential Transcriptional Responses of SA187-colonizedArabidopsis to Heat Stress

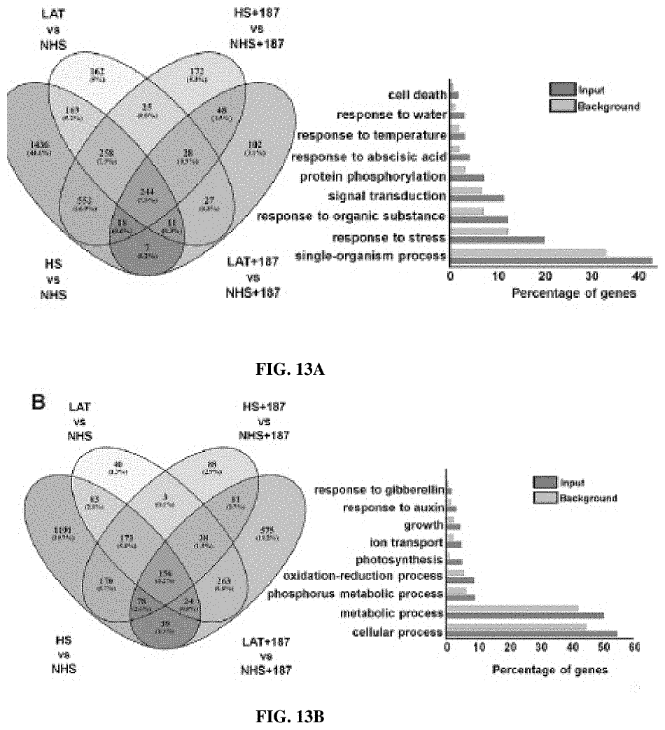

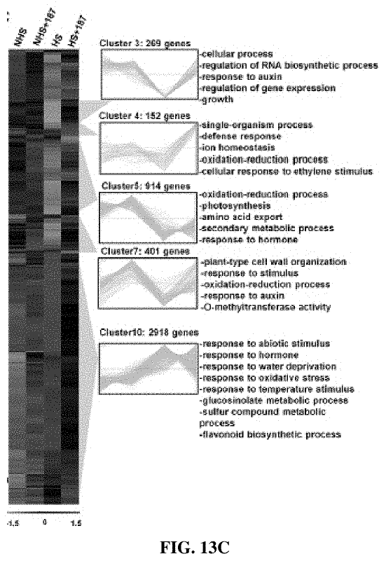

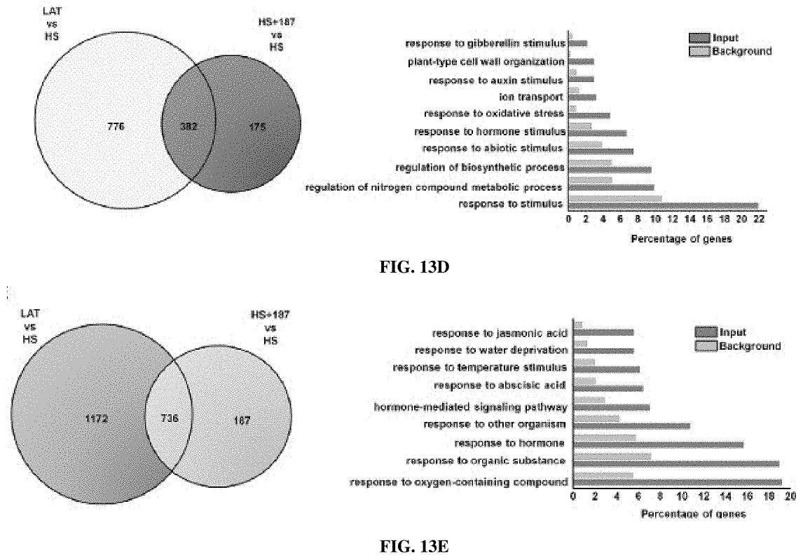

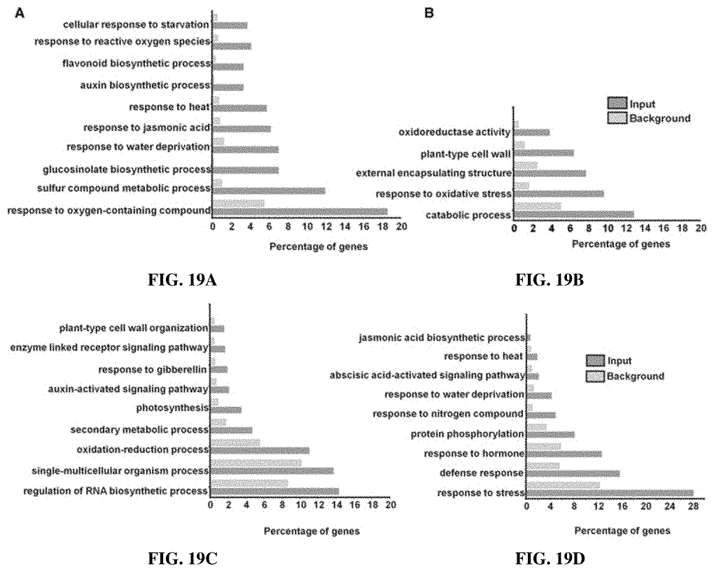

To determine the genome-wide extent of HS-induced changes, transcriptome profiling of SA187-colonized and non-colonized 15-day-old plants was performed under non-HS (NHS), LAT, and direct HS(HS) conditions (FIG. 12D). In comparison to NHS plants and considering a log 2 FC≥2 or ≤−2(P<0.05), HS displayed 4609, LAT1704, HS+187 2130, while LAT+187 1740 DEGs (FIGS. 2A and B, 18A and B). Among all treatments, HS showed a maximum number of 2,627 DEGs that were unique to 44° C. Gene enrichment analysis (AgriGO platform, FDR≤0.05) for the common genes in all HS treatments is presented in FIGS. 19A and B. Gene ontology (GO) analysis of the 1,436 up-regulated HS-specific DEGs indicated enrichment in protein phosphorylation and signal transduction, and responses to abscisic acid, temperature, water, and cell death, while the 1,191 down-regulated DEGs showed enrichment for processes of oxidation-reduction, photosynthesis, ion transport, growth, and responses to auxin and gibberellin (FIGS. 13A and B). In summary, the HS-induced gene sets are typical for plants exposed to severe stress halting growth and inducing stress responses and survival.

Subsequent studies investigated how SA187 affects the transcriptome of A. thaliana upon HS. Under NHS, 303 genes were differentially expressed in SA187-colonized plants when compared to non-col-nized control plants (FIG. 19A-D). In contrast, 2,130 DEGs were found in SA187-colonized (HS+187) compared to non-colonized HS-treated plants (HS) (FIG. 19A-D). The transcriptome data were organized into 10 groups by hierarchical clustering and analyzed for gene ontology enrichment (FIG. 13C). Cluster 3 contains genes that are down-regulated under HS but not in SA187-colonized plants(HS+187) showing enrichment in the regulation of gene expression, RNA biosynthesis, and response to auxin. Cluster 4 genes, which are significantly induced by SA187 under HS conditions, are involved in processes of defense, ion homeostasis, oxidation-reduction, and response to ethylene. Cluster 7, representing genes that are up-regulated by SA187 independently of the growth conditions, is enriched in cell wall organization, oxidation-reduction, and response to auxin. Cluster 5 displays commonly down-regulated genes in HS and HS+187, which are mainly involved in oxidation-reduction, photosynthesis, amino acid export, secondary metabolism, and hormone responses. Finally, cluster 10 comprises the largest set of differentially expressed genes that are strongly up-regulated by HS but show only moderate induction by HS+187. These genes mainly consist of HS-regulated genes responding to abiotic stimulus, hormone, water deprivation, oxidative stress, temperature, glucosinolate, and sulfur metabolism, as well as flavonoid biosynthesis.

Comparing LAT with HS (FIG. 19A-D), the 1,157 up-regulated genes were enriched for biosynthetic processes, responses to auxin and gibberellin, and photosynthesis, while the GO enrichment for the 1,907 down-regulated gene set was enriched for genes involved in response to stress, defense, heat, hormone, and water (FIGS. 19C and 19D).

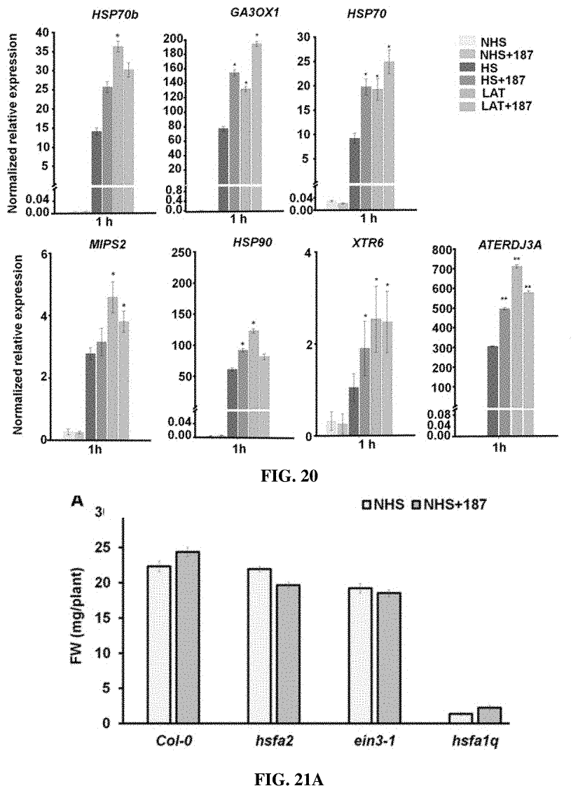

Since SA187 and LAT modulate the A. thaliana HS transcriptome, a search for common features between the two treatments was conducted. This analysis revealed that the large majority of HS+187DEGs overlap with those upon LAT treatment 69% (382) of up- and 80% (736) of down-regulated DEGs (FIG. 20). The commonly up-regulated DEGs of HS+SA187 and LAT were enriched for cell wall organization and responses to auxin and gibberellin, while the down-regulated DEGs showed GO enrichment for responses to temperature, water, ABA, SA, and JA biosynthesis (FIGS. 13D and E). The vast overlap in the HS DEG transcriptomes suggests that SA187 and LAT use a common mechanism to protect Arabidopsis from extreme temperatures.

SA187 Enhances the Expression of Heat-Responsive and Memory Genes Upon Heat Stress

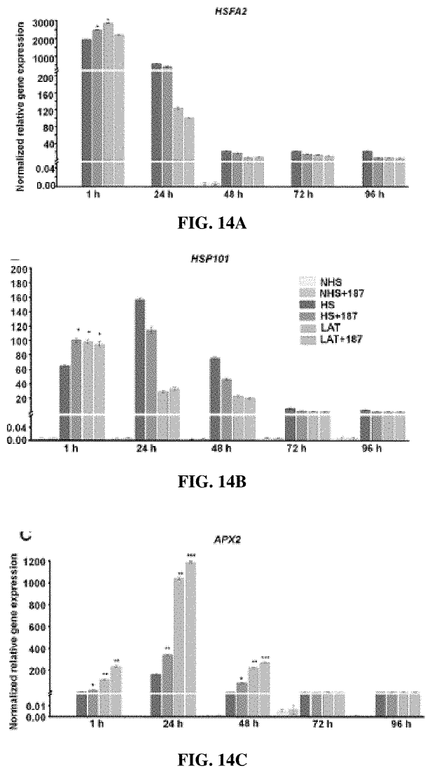

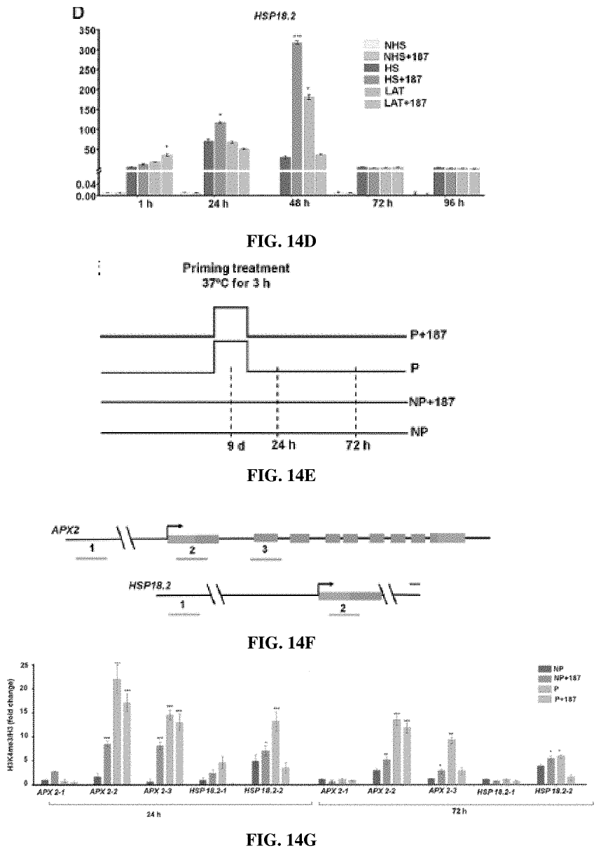

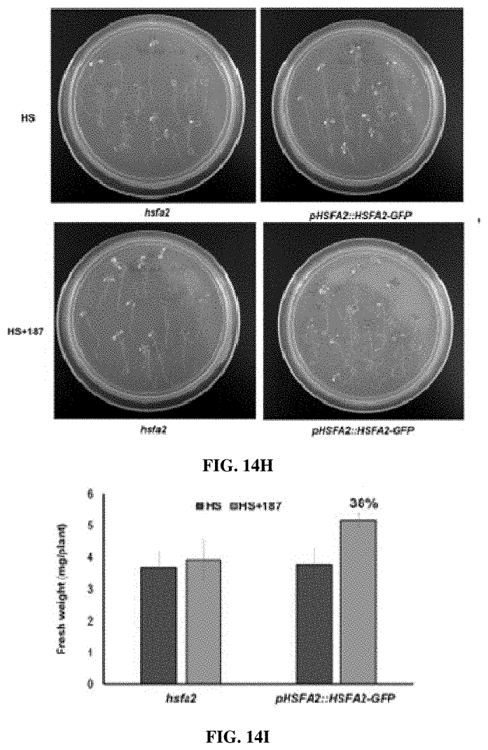

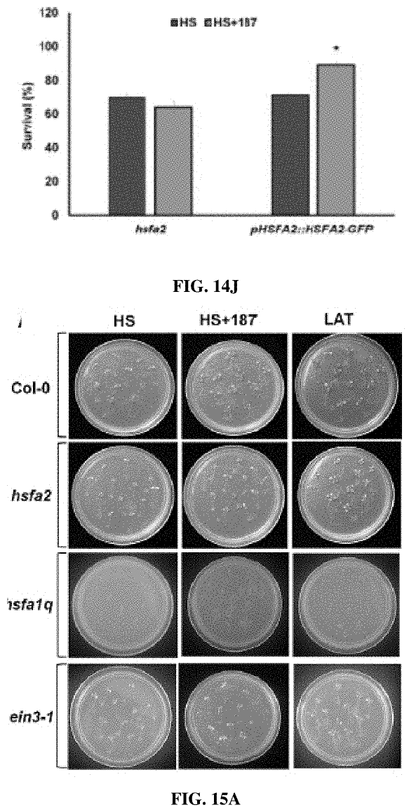

Studies investigated the expression pattern of 8 heat-responsive genes (HSP101, HSP70, HSP70b, GA3OX1, ATERDJ3A, HSP90, XTR6, and MIPS2), HSFA2, and 2 memory genes HSP18.2 andAPX2 (Liu et al, 2018). qRT-PCR analysis of heat-responsive genes was performed at 1 h after exposure to 44° C. for 30 min (FIG. 20) and at 1, 24, 48, 72, and 96 h for HSFA2, HSP101, APX2, and HSP18.2 (FIG. 14A-D). Under ambient conditions with no HS treatment (NHS), SA187 (NHS+187) did not change the expression of these heat-responsive and memory genes (FIGS. 14A-D and FIG. 20). Compared to either non-colonized or non-thermoprimed plants, HS+187 and LAT plants showed higher transcript levels ofHSFA2, HSP101, APX2, and HSP18.2 genes in the time range oft-48 h upon 44° C. HS treatment (FIG. 14A-D). At later time points, expression of the thermo- and 187-primed genes returned to normal or even lower transcript levels than in unprimed plants (FIG. 14A-D). This pattern of gene expression correlates with the improved survival of thermoprimed and SA187-colonized plants under severe HS conditions.

SA187 Induces Sustained H3K4Me3 Levels at Arabidopsis APX2 and HSP18.2 Gene Loci

Recently, chromatin modifications, in particular histone H3K4me3, were shown to be involved in maintaining the prolonged expression of heat-responsive memory genes, such as APX2 and HSP18.2, to protect plants from subsequent severe HS (Liu et al, 2015; Lamke et al, 2016a; Lämke et al, 2016b; Lämke et al., 2017). To test whether H3K4me3 is also involved in providing elevated and prolonged expression of the HS memory genes in SA187-colonizedplants, H3K4me3 levels were evaluated at the APX2 and HSP18.2 gene loci as representatives of the HS memory-related genes in 9-day-oldplants (FIGS. 14E and 14F). ChIP-qPCR was performed of plants that were primed at 37° C. for 3 h (P, P+187) and their respective non-primed controls (NP, NP+187) before recovery for 24 and 72 h at 22° C. (FIGS. 14E and F). In accordance with previous studies (Lämke et al, 2016a; Liu et al, 2018 17,28), the 37° C. thermoprimed plants showed enrichment of H3K4me3 at regions 2 and 3 of APX2 and region 2 ofHSP18.2 gene (FIG. 14G). The ChIP assays of SA187-colonized plants(NHS+187) also showed significant enrichment for H3K4me3 at the APX2 and HSP18.2 loci (FIG. 14G). Importantly, although expression levels had been reset to normal levels for APX2 and HSP18.2 at 72 h after HS treatment (FIGS. 14C and 14D), H3K4me3 levels remained enriched in both thermoprimed and 187-colonized plants (FIG. 14G), indicating that SA187 colonization enhances H3K4me3 accumulation at HS memory gene loci.

SA187-Induced Heat Stress Tolerance is Mediated by HSFA2 and Ethylene Signaling

Since HSFA2 regulates HS-responsive genes (Liu & Charng, 2013), studies examined whether SA187-induced thermotolerance might also be mediated via HSFA2. hsfa2 mutant plants were strongly compromised in the beneficial effect of both SA187 and LAT, indicating thatHSFA2 is important for SA187- and thermopriming-induced heat tolerance (FIG. 14A-C). The beneficial effect of SA187 was further recovered in HSFA2 complementation line pHSFA2::HSFA2-GFP (FIG. 14H-J).

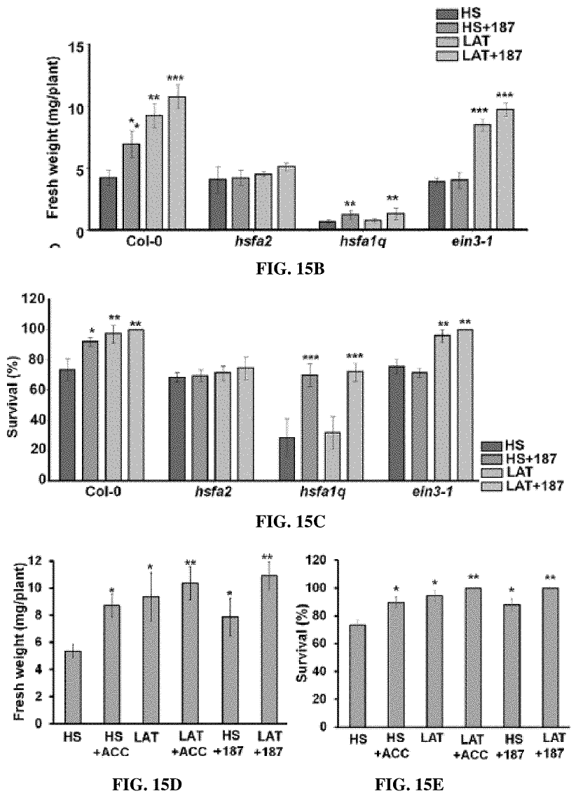

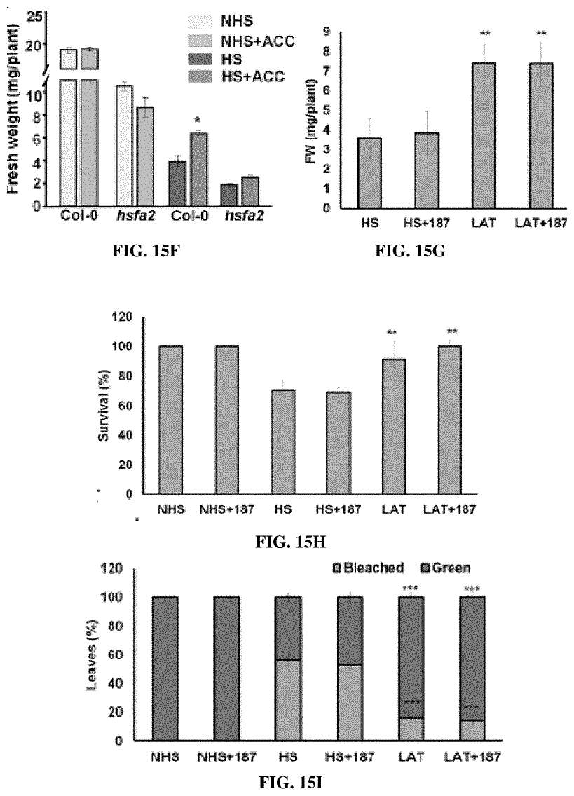

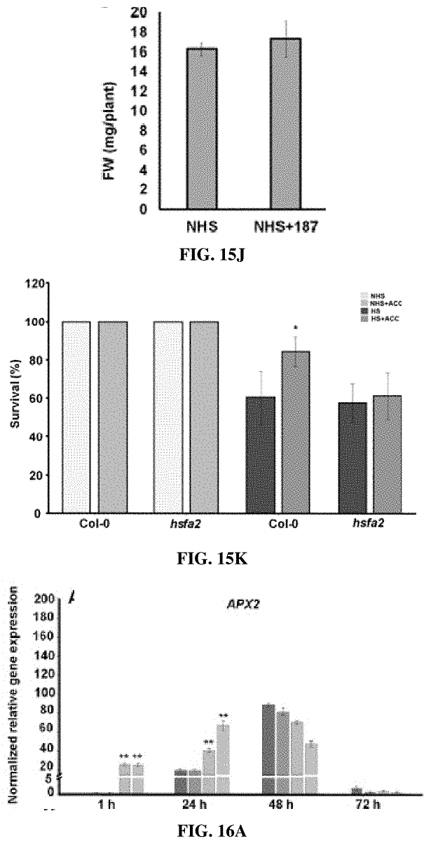

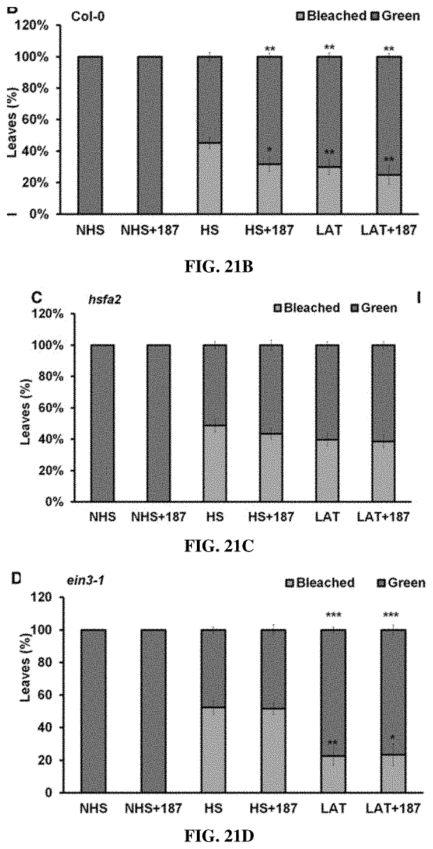

Thermopriming regulates HSFA2via the set of four upstream transcription factors HSFA1A, B, D, and E. To test whether SA187-induced thermotolerance is also dependent on HSFA1s, a quadruple HSFA1A, B, D, and E (hsfa1q) mutant was analyzed for LAT- and SA187-induced thermotolerance. As shown in FIG. 15A-C, thermopriming was completely compromised in hsfa1q mutant plants, whereas SA187 could still enhance the survival of HS-treated hsfa1q (FIG. 21A for control plants and 21B-21D for green leaves).

A previous study on SA187 under salt stress (de Zélicourt et al, 2018) showed that SA187 rescues plants from salt stress via the ethylene signaling pathway. To test whether ethylene plays a role in SA187-induced thermotolerance, the ethylene insensitive ein3-1 and ein2-1 mutants were analyzed. As shown in FIG. 15A-C, ein3-lmutants were strongly compromised in SA187-induced thermotolerance but not by thermopriming (LAT), indicating that EIN3 mediatesSA187-induced thermotolerance but not thermopriming in A. thaliana. Since ein2-1 mutants were similarly unresponsive toSA187 but fully responsive to LAT thermopriming in thermotolerance tests (FIG. 15G-J for ein2-1), the conclusion is that ethylene signaling mediates SA187-induced plant thermotolerance via the EIN3 transcription factor. Importantly, thermopriming was not compromised in ein2-1 or in ein3-1 mutants (FIG. 15A-C), indicating that thermopriming functions independently of ethylene signaling. To corroborate that ethylene induces thermotolerance in plants, Arabidopsis were also treated with a low dose of the ethylene precursorl-aminocyclopropane-1-carboxylic acid (ACC). Plant thermotolerance could be similarly improved by 1 μM ACC as by SA187 colonization (FIGS. 14D and E), further supporting the notion that SA187 induced HS tolerance is mediated by plant ethylene signaling.

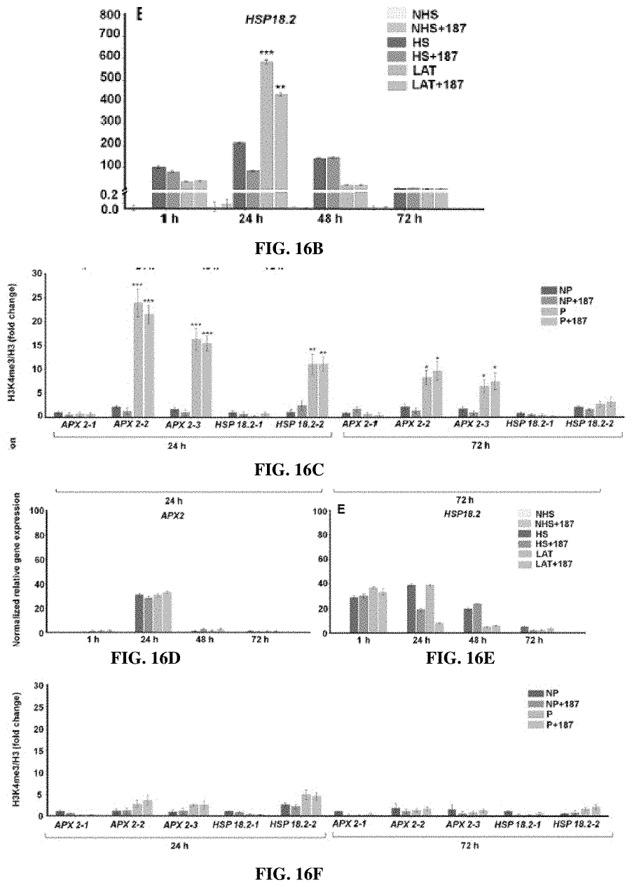

To clarify whether ethylene acts upstream or in parallel to HSFA2 signaling, hsfa2 mutant plants were grown in the presence or absence of 1 μM ACC before HS treatment at 44° C. Fresh weight (FIG. 15F) and survival measurements (FIG. 15K) clearly showed that HSFA2 is necessary for mediating ethylene signaling, hereby placing ethylene signaling upstream of HSFA2-mediatedthermotolerance. To confirm that ethylene mediates thermotolerance by SA187, qPCR and ChIP-qPCR of ein3-1 mutant plants were performed forAPX2 and HSP18.2. SA187-colonized (HS+187) ein3-1 plants did not display higher and prolonged transcripts levels in the two HS memory genes HSP18.2 and APX2 than HS plants (FIGS. 16A and B), confirming EIN3-dependent induction of thermotolerance bySA187. However, 37° C. thermoprimed ein3-1 plants exhibited higher expression levels for these memory genes compared to non-primed HS-induced levels, showing that thermopriming functions independently of EIN3. ChIP-qPCR of ein3-1 that were primed at 37° C. for 3 h (P) after 24 and 72 h of recovery at 22° C. (FIG. 16C) showed that the 37° C. thermoprimed plants had enrichedH3K4me3 levels at regions 2 and 3 of APX2 and region 2 ofHSP18.2 compared to the non-primed ein3-1 control (NP)(FIG. 16C). In contrast, ChIP assays of SA187-colonized plants(NHS+187) did not show H3K4me3 enrichment at the APX2 andHSP18.2 loci (FIG. 16C), confirming that EIN3 mediates H3K4me3priming by SA187.

To confirm that hsfa2 mediates thermopriming and SA187-induced thermotolerance, qPCR and ChIP-qPCR were also performed of ein3-1 and hsfa2 mutants for APX2 and HSP18.2, and the qPCR data for APX2 and HSP18.2 did not show higher expression upon LAT thermo- or SA187-priming than in naïve non-treated NHS hsfa2 mutants (FIGS. 16D and E). Likewise, at 24 and 72 h of recovery at 22° C. from HS, ChIP-qPCR of both 37° C. thermoprimed and SA187-colonized hsfa2 mutants showed no significant enrichment ofH3K4me3 at regions 2 and 3 of APX2 and region 2 of HSP18.2 gene loci (FIG. 16F). Taken together, these results indicate HSFA2 mediates thermotolerance of both SA187 and thermopriming.

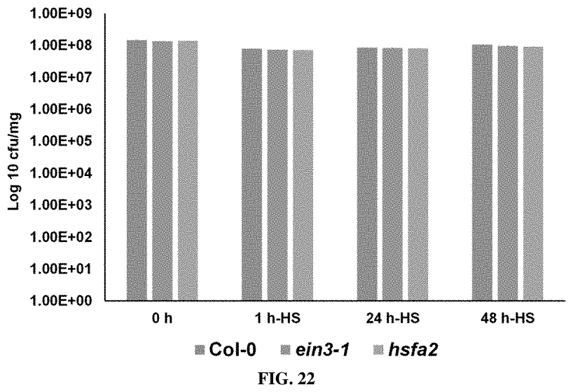

To eliminate the possible discrepancies in bacterial colonization, the effect of hsfa2, ein3-1 mutants, and 44° C. heat stress on SA187 colonization was evaluated. The results at 0, 1, 24, and 48 h of heat stress in Col-0, hsfa2, and ein3-1 mutants revealed no significant differences in colony forming unit (CFU) levels between wild type and mutants, indicating that the mutants do not affect the overall colonization in A. thaliana under NHS or HS conditions (FIG. 22).

SA187 does not Alter Wheat Microbiome Composition

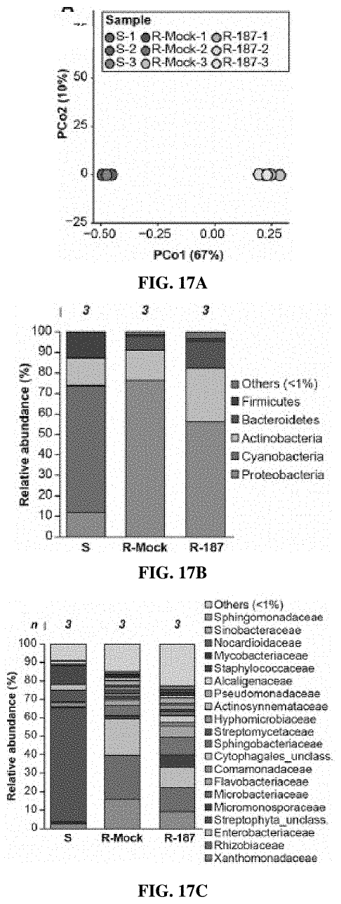

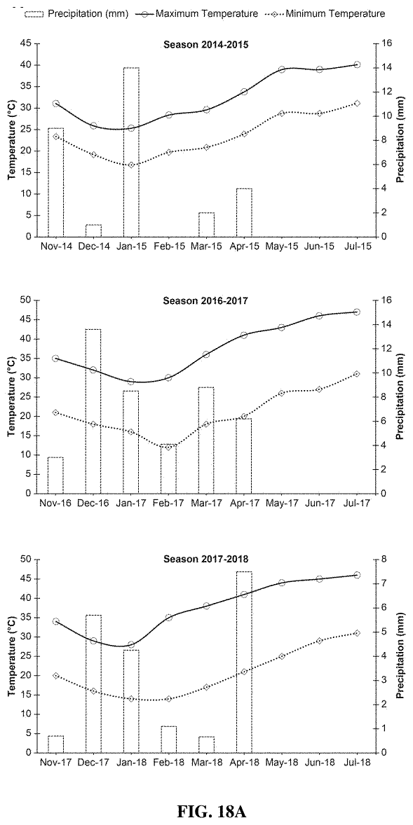

To explore whether the inoculation of SA187 changes the natural microbiome of the wheat root endosphere, the bacterial composition of the soil and root endosphere of wheat plants was determined. A principal component analysis of the relative abundance of operational taxonomic units (OTUs) showed a clear separation between soil and the SA187-treated or non-treated root endosphere samples (FIG. 17A). Microbiome analysis of the V5-V7 region of the 16S rRNA gene demonstrated that the three samples exhibited a different composition of bacterial phyla with a high abundance of Cyanobacteria, Firmicutes in soil, whereas Proteobacteria and Actinobacteria were highly abundant in the wheat root endosphere. This observation was made for a number of crop plants, such as maize, barley, rice, and grapevine (Lundberg et al, 2012; Bulgarelli et al, 2015 30-31). PERMNOVA showed that the bacterial communities between non-treated and SA187-treated root endosphere samples were not significantly different (pairwise t=1.23, P>0.23), while ANOISM (R: 0.8107, significance: 0.0039) indicated significant differences. These results reveal that non-treated and SA187-treated root samples did not differ in overall species composition, but they differ in overall heterogeneity of species composition (beta diversity), indicating that the application of SA187 did not change the composition of the wheat microbiome (FIG. 17B). SA187-treated or non-treated root endosphere samples exhibited twenty different families at >1% abundance (FIG. 17C) and compared to soil, wheat root endosphere samples were dominated by Xanthomonadaceae, Rhizobiaceae, and Enterobacteriaceae. Streptomycetaceae, Actinosynnemataceae, and Staphylococcaceae were less abundant in root samples in comparison to soil (FIG. 17C). SA187 changed the distribution of bacterial families in roots by a decrease in Xanthomonadaceae, Rhizobiaceae, and Enterobacteriaceae but an increase in Micromonosporaceae and Microbacteriaceae. In summary, although SA187 did not significantly change the microbial community itself, the percentage of microbes varied after SA187 treatment.

### DISCUSSION

The increases in global temperatures have a significant negative impact on agriculture worldwide and pose a serious threat to global food security. To cope with this challenge, the current studies support the use of beneficial microbes. Several studies reported that endophytes can enhance plant growth under abiotic stress conditions (Márquez et al, 2007; Avramova, 2015; de Zélicourt et al, 2018; Saad et al, 2020). So far, however, the application in open-field agriculture of thermotolerance by beneficial microbes was not investigated. This work shows that the beneficial root endophyte SA187 enhances thermotolerance of wheat and Arabidopsis under controlled laboratory conditions. Importantly, the data show that in three independent vegetation periods, SA187 enhances thermotolerance and yield of wheat in open-field agriculture without significantly affecting the microbiome composition of the crop. These results suggest that beneficial microbes such as SA187 might be efficient means to improve global crop productivity under extreme environmental conditions.

To investigate the molecular mechanism of endophyte-induced thermotolerance, SA187-induced thermotolerance in the model plant Arabidopsis thaliana was investigated. The experimental evidence suggests that SA187 and thermopriming/heat acclimation use a partially overlapping signaling network for inducing thermotolerance. These studies showed that SA187 induces thermotolerance to a similar degree as heat acclimation by hyper-induction of HS-responsive and HS memory genes. Interestingly, the majority of the genes induced by HS was not induced in thermoprimed or SA187-colonized plants. A comparison of the DEGs of SA187-colonized and thermoprimed plants revealed a large overlap (FIGS. 13D and E), suggesting that thermotolerance by SA187 engages an overlapping signaling network with thermopriming for achieving heat protection. Thermopriming is associated with a transcriptional memory resulting in faster and stronger expression of heat-responsive genes upon a repeated stress signal (Stief et al, 2014; Sedaghatmehr et al, 2016; D'Urso & Brickner, 2017). Moreover, in both SA187-colonized and thermoprimed plants, gene expression of the HS memory genes APX2 and HSP18.2 was up-regulated and higher transcript levels were maintained up to 48 h after HS. Importantly, the persistent expression of these genes is known to be associated with improved plant growth under extreme temperatures (Lämke et al, 2016a; Lämke et al, 2016b; Lämke & Baurle, 2017). The transcriptional regulation of heat responsive genes is controlled by epigenetic factors that help maintain priming memory (Brzezinka et al, 2016), and elevated histone H3K4 methylation levels and enhanced chromatin accessibility are involved in the thermoprimed memory process (Lämke et al, 2016a; Liu et al, 2018). This thermopriming memory is HSFA2 dependent as plants require active HSFA2 in order to elevate histone H3K4 methylation levels for memory genes. Recently, the involvement of HSFA2 was also shown for transgenerational thermomemory in A. thaliana (Liu et al, 2019). HSFA2 and H3K27me3 demethylase RELATIVE OF EARLY FLOWERING 6 (REF6) form a positive feedback loop to transmit long-term epigenetic memory of heat. HSFA2 is activated by heat-induced demethylation and then HSFA2 further up-regulates the expression of the H3K27me3 demethylase REF6, establishing a positive feedback loop between H3K27me3 demethylation and HSFA2 up-regulation that is critical to the thermomemory establishment and transmission to progeny (Liu et al, 2019). However, an involvement of chromatin modifications in providing HS tolerance by beneficial microorganisms is hitherto unknown. The data shows that similar to thermopriming, SA187 induces sustained accumulation of H3K4me3 at APX2 and HSP18.2 gene loci (FIG. 14G).

HSFA2 is required for the maintenance of HS-induced memory by activating the expression of HS genes (Schramm et al, 2006; Lämke et al, 2016a; Lämke et al, 2016b). The phenotype and chromatin data show that SA187- and thermopriming-induced thermotolerance depend on HSFA2 as mutants in hsfa2 are compromised in both processes. During HS, HSFA2 is strongly induced, and this process depends on the set of the four transcription factors HSFA1A, B, D, and E. Importantly, quadruple hsfa1q mutant plants are compromised in thermopriming, but not SA187-induced thermotolerance. These data show that SA187 regulates HSFA2 by a different mechanism than heat acclimation. The data shows that SA187-induced thermotolerance is compromised in ein3-1 and ein2-1 mutant plants, but not upon thermopriming. In summary, the present analysis shows that thermopriming- and SA187-induced thermotolerance are both mediated by HSFA2, but thermopriming uses HSFA1 transcription factors, whereas SA187 uses the ethylene pathway and the EIN3 transcription factor. EIN3 likely does not act directly on the HSFA2 promoter, but by its downstream abiotic stress-inducible ERF transcription factors (Solano et al, 1998; Xing et al, 2017). Overexpression of ERF1 in Arabidopsis by the 35S CaMV promoter results in enhanced heat tolerance and up-regulation of heat tolerance genes (Cheng et al, 2013). Depending on the stress conditions, ERFs activate a specific set of stress response genes by binding to the cis acting GCC box or its substitute TCC box and DRE elements which are also present in the HSFA2 promoter (Yang et al, 2015; Prajapati et al, 2019; Xie et al, 2019). In summary, our data suggest that SA187-induced thermotolerance could be mediated via EIN3-regulated expression of ERFs that subsequently act on HSFA2 (FIG. 7). In terms of applying thermotolerance in agriculture, thermopriming is a transient mechanism and is hard to apply on field-grown crops. In contrast, SA187 permanently colonizes plants, rendering them constitutively thermotolerant without any further treatment, making root endophytes a powerful tool to maintain crop production under the adverse conditions of global warming.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. A plant substrate comprising an effective amount of Enterobacter sp. SA187 to inhibit or reduce heat stress in the plant, wherein the plant substrate is selected from a group consisting of soil, peat, compost, vermiculite, perlite, sand, clay and combinations thereof.

2. The plant substrate according to claim 1, further comprising one or more additional plant growth-promoting bacteria.

3. The plant substrate according to claim 2, wherein the one or more plant growth-promoting bacteria are selected from the group consisting of Paenibacillus polymyxa strain A26, a Alcaligenes faecalis strain AF, and a combination thereof.

4. A plant part coated with an effective amount of Enterobacter sp. SA187 to provide the seed with resistance to heat stress conditions as the seed grows, wherein the plant part is a plant seed or a plant root.

5. The plant seed according to claim 4, further coated with one or more additional plant growth-promoting bacteria.

6. The plant part according to claim 5, wherein the one or more plant growth-promoting bacteria is selected from the group consisting of Paenibacillus polymyxa strain A26, a Alcaligenes faecalis strain AF, and a combination thereof.

7. A method of providing a seed or plant with resistance to heat stress conditions comprising: contacting the seed or a root of the plant with the substrate of claim 1.

8. The method of claim 7, comprising coating the seed or root of the plant with an effective amount of Enterobacter sp. SA187 provide the plant with resistance to heat stress.

9. The method of claim 7, comprising inoculating the plant's rhizosphere with SA187.

10. The method of claim 7 comprising coating the plant seed with an effective amount of Enterobacter sp. SA187.

11. The method of claim 7, wherein the plant is selected from the group consisting of alfalfa, cotton, wheat, maize, soybean, oat, barley, potato, and sugar beets.

12. A seed coating composition comprising: Enterobacter sp. SA187 encapsulated with a non-toxic, biodegradable coating; and a coating adhesive.

13. The seed coating composition of claim 12, wherein the coating comprises gelatin, cellulose, alginate, xanthum, or a combination thereof.

14. The method of claim 7, wherein the heat stress is a temperature of up to 50° C. above the plant's ambient temperature for growth.

15. The method of claim 7 wherein the plant is grown at a temperature above 90 F (Fahrenheit) and up to 104 F.

16. The method of claim 15, wherein the plant is grown at a temperature above 104 F and up to 130 F.
